(19) United States
(12) Patent Application Publication
(10) Pub. No.: US 2026/0237385 A1
(43) Pub. Date: Aug. 13, 2026

(54) CONTROL OF AN APPARATUS USING KEYPHRASE DETECTION AND A STATE MACHINE

(71) Applicant: Analog Devices, Inc., Wilmington, MA (US)

(72) Inventors: Jonathan Samuel YEDIDIA, Cambridge, MA (US); Cristobal ALESSANDRI, Boston, MA (US)

(21) Appl. No.: 19/145,740

(22) PCT Filed: Jan. 4, 2024
(86) PCT No.: PCT/US2024/010360

§ 371 Date: Jul. 3, 2025

Related U.S. Application Data
(60) Provisional application No. 63/478,456, filed on Jan. 4, 2023.

(51) Int. Cl. G10L 15/193; G10L 15/08

(52) U.S. Cl. CPC G10L 15/193; G10L 2015/088

(57) ABSTRACT

Technologies are provided for keyphrase detection. In some aspects, a language model based on multiple keyphrases can be generated. The language model can then be merged with a second language model that is based on an ordinary spoken natural language, resulting in a keyphrase recognition model. The keyphrase recognition model can be supplied to an apparatus. The apparatus can receive an audio signal representative of speech, and can detect one or more particular keyphrases based on applying the keyphrase recognition model to the speech. In response to detecting the particular keyphrase(s), the apparatus can be caused to execute one or more control operations. Implementation of a state machine can cause the apparatus to execute the control operation(s), where the state machine is based on at least one of the particular keyphrase(s).

### CROSS-REFERENCE TO RELATED APPLICATIONS

This patent application claims the benefit of and priority to U.S. Provisional Patent Application No. 63/478,456, filed Jan. 4, 2023. The contents of which application are hereby incorporated herein by reference in their entireties.

### BACKGROUND

Existing keyphrase recognition systems are typically based on machine-learning (ML) techniques. Such systems are generated by collecting a substantial amount of data of people with different accents speaking the keyphrase, and then training a machine-learning model, such as a neural network, to provide a recognition when the keyphrase is spoken. Generating a keyphrase recognition system in such a fashion is intensive in terms of both computing resources and human resources. As a result, generating a new keyphrase recognition system or modifying an existing one by adding new keyphrases tends to be burdensome.

Keyphrase detection can be used to control, using speech, one or more apparatuses. Such a control can ultimately depend on the machine-learning model that is employed for keyphrase detection. Thus, in commonplace technologies, the implementation of control using speech may be hindered by the burdens involved in the generation of such a machine-learning model.

Therefore, much remains to be improved in technologies for the generation of keyphrase recognition systems and their application to practical problems.

### SUMMARY

In an aspect, a method of keyphrase recognition comprises generating a language model based on multiple keyphrases, merging the language model with a second language model that is based on an ordinary spoken natural language, resulting in a keyphrase recognition model, receiving an audio signal representative of speech, and detecting, based on applying the keyphrase recognition model to the speech, a particular keyphrase of the multiple keyphrases.

Another aspect includes a system of one or more devices comprising at least one processor and at least one memory devices storing processor-executable instructions that, in response to being executed by the at least one processor, cause the system to perform the above-noted method.

Yet another aspect includes at least one non-transitory computer-readable storage medium having processor-executable instructions encoded thereon that, in response to execution by at least one processor, individually or in combination, cause a system of devices to perform operations comprising: generating a language model based on multiple keyphrases; merging the language model with a second language model that is based on an ordinary spoken natural language, resulting in a keyphrase recognition model; receiving an audio signal representative of speech; and detecting, based on applying the keyphrase recognition model to the speech, a particular keyphrase of the multiple keyphrases.

Still another aspect includes a method comprising receiving, by an apparatus, an audio signal representative of speech, detecting, based on applying a keyphase recognition model to the speech, one or more particular keyphrases of multiple keyphrases, wherein the keyphrase recognition model is based on the multiple keyphrases; and causing, by applying the state machine, an apparatus to perform one or more control operations based on the one or more particular keyphrases.

A further aspect includes an apparatus comprising: at least one processor, and at least one memory device storing processor-executable instructions that, in response to being executed by the at least one processor, cause the apparatus at least to: receive an audio signal representative of speech; detect, based on applying a keyphase recognition model to the speech, one or more particular keyphrases of multiple keyphrases, wherein the keyphrase recognition model is based on the multiple keyphrases; and cause, by applying a state machine, execution of one or more control operations based on the one or more particular keyphrases, wherein the state machine is based on a subset of the multiple keyphrases.

Still another aspect includes at least one non-transitory computer-readable storage medium having processor-executable instructions encoded thereon that, in response to execution by at least one processor, individually or in combination, cause an apparatus to perform operations comprising: receiving an audio signal representative of speech; detecting, based on applying a keyphrase recognition model to the speech, one or more particular keyphrases of multiple keyphrases, wherein the keyphrase recognition model is based on the multiple keyphrases; and causing, by applying a state machine, execution of one or more control operations based on the one or more particular keyphrases, wherein the state machine is based on a subset of the multiple keyphrases.

### BRIEF DESCRIPTION OF THE DRAWINGS

The accompanying drawings form part of the disclosure and are incorporated into the subject specification. The drawings illustrate example aspects of the disclosure and, in conjunction with the following detailed description, serve to explain at least in part various principles, features, or aspects of the disclosure. Some aspects of the disclosure are described more fully below with reference to the accompanying drawings. However, various aspects of the disclosure can be implemented in many different forms and should not be construed as limited to the implementations set forth herein. Like numbers refer to like elements throughout.

FIG. 1 is a block diagram of an example of a computing system for keyphrase detection, in accordance with one or more aspects of this disclosure.

FIG. 2 is a block diagram of an example of a computing system for keyphrase detection, in accordance with one or more aspects of this disclosure.

FIG. 3A is a listing of a recognition output over time for an example of partial and final recognitions, in accordance with one or more aspects of this disclosure.

FIG. 3B is a listing of a recognition output over time for another example of partial and final recognitions, in accordance with one or more aspects of this disclosure.

FIG. 4 is a block diagram of an example of a computing system for keyphrase detection, in accordance with one or more aspects of this disclosure.

FIG. 5 is a block diagram of an example of an apparatus for keyphrase detection, in accordance with one or more aspects of this disclosure.

FIG. 6 is a graph that represents an example of a state machine, in accordance with one or more aspects of this disclosure.

FIG. 7A is an example of a listing of statements that configure a state machine, in accordance with one or more aspects of this disclosure.

FIG. 7B is another example of a listing of statements that configure a state machine, in accordance with one or more aspects of this disclosure.

FIG. 7C is another listing of statements that configure a state machine, in accordance with one or more aspects of this disclosure.

FIG. 7D is an example of a data structure, in accordance with one or more aspects of this disclosure.

FIG. 8A is a graph that represents another example of a state machine, in accordance with one or more aspects of this disclosure.

FIG. 8B is another example of a listing of statements that configure a state machine, in accordance with one or more aspects of this disclosure.

FIG. 9A is a graph that represents yet another example of a state machine, in accordance with one or more aspects of this disclosure.

FIG. 9B is another example of a listing of statements that configure a state machine, in accordance with one or more aspects of this disclosure.

FIG. 10A is a graph that represents yet another example of a state machine, in accordance with one or more aspects of this disclosure.

FIG. 10B is another example of a listing of statements that configure a state machine, in accordance with one or more aspects of this disclosure.

FIG. 11 is a block diagram of an example of a system of devices that can provide various functionalities of keyphrase detection and, in some cases, execution of control operation(s), in accordance with one or more aspects of this disclosure.

FIG. 12 is a flowchart of an example of a method for detecting keyphrases, in accordance with one or more aspects of this disclosure.

FIG. 13 is a flowchart of an example of a method for generating a language model, in accordance with one or more aspects of this disclosure.

FIG. 14 is a flowchart of an example of a method for detecting a keyphrase, in accordance with one or more aspects of this disclosure.

FIG. 15 is a flowchart of an example of a method for controlling operation of an apparatus using speech, in accordance with one or more aspects of this disclosure.

### DETAILED DESCRIPTION

The present disclosure recognizes and addresses, among other technical challenges, the issue of keyphrase detection in the interaction with computing devices. Reliable detection of spoken keyphrases can permit using speech to interact with computing devices or other types of apparatuses having computing resources. Keyphrases can be phrases that cause a computing device or apparatus to be energized (e.g., “start cleaning” or “hey analog”) or to power off (e.g., “shut down”). Keyphrases also can be phrases that cause the computing device or apparatus to execute a task (e.g., “turn on the lights,” “lock patio doors,” or “compact trash”). Although existing technologies for keyphrase detection may have satisfactory reliability, the amount of computing resources and time involved in the development of such technologies may hinder ease of implementation and may lack flexibility to expand the base of keyphrases that they can detect.

As is described in greater detail below, aspects of this disclosure can configure a keyphrase recognition model based on multiple keyphrases, and can then apply the configured keyphrase recognition model to detect one or several of the multiple keyphrases in speech in a natural language. Aspects of this disclosure can configure the keyphrase recognition model by generating, using the multiple keyphrases, a domain-specific language model that is then combined with a wide-vocabulary language model that is based on an ordinary spoken natural language. The configuration of the keyphrase recognition model can be readily modified by updating data defining the multiple keyphrases and generating an updated keyphrase recognition model. Additionally, configuration of the keyphrase recognition model is dramatically less time intensive than configuration of existing keyphrase detection technologies. Indeed, configuration of the keyphrase recognition models of this disclosure can be accomplished as easily as compiling a new version of a computer program.

After a keyphrase recognition model has been configured, aspects of the disclosure can detect one or several particular keyphrases by applying the configured keyphrase recognition model to speech. Detection can use automated speech recognition (ASR) to identify a sequence of words present in the speech, and can analyze a suffix of such a sequence to determine if a particular keyphrase is present in the speech. Presence of the particular keyphrase yields a recognition of the particular keyphrase. In some cases, an initial recognition of the particular keyphrase results in the detection of the particular keyphrase. In other cases, the recognition of the particular keyphrase can be deemed preliminary, and additional recognition of the particular keyphrase after a latency time period during which additional speech may be received can confirm that the particular keyphrase has been recognized. Such confirmation results in the detection of the particular keyphrase. The latency time period is configurable and can be specific to the particular keyphrase.

Detection of one or more particular keyphrases can cause an apparatus to perform (or execute) a control operation or a sequence of control operations. In some cases, detection of the particular keyphrase(s) is combined with the implementation (or application) of a state machine to cause the apparatus to perform (or execute) the control operation or the sequence of control operations. The state machine includes multiple states and is based on at least one of the particular keyphrase(s) that have been detected. The state machine can be defined or otherwise configured by means of a listing of statements that defines a graph representing the state machine. Each statement in the list of statements defines an input event in the state machine, at least one node in the graph, and an edge in the graph. The state machine can be configured separately from the keyphrase recognition model, thus adding flexibility to the control of the apparatus. Such flexibility includes straightforward reconfiguration of the state machine, to attain an updated or otherwise desired behavior of the control apparatus.

In sharp contrast to commonplace technologies, aspects of this disclosure avoid using machine-learning techniques, and provide a computationally efficient approach that can reduce the use of computing resources, such as but not limited to a compute time, memory storage, network bandwidth, and/or similar resource. Indeed, techniques, devices, and systems of this disclosure can implement keyphrase detection that is performed in the presence of noise and/or or in cases where the speaker has accented speech. Such techniques, devices, and systems can be operational even in the absence of network connectivity. Besides computational efficiency and versatility, the techniques, devices, systems, and computer-program products of this disclosure can provide improved keyphrase detection performance over existing technologies. Further, by using a state machine in combination with the keyphrase detection of this disclosure, the control of an apparatus can be achieved with further efficiency, which efficiency is superior to that of commonplace control technologies based on speech.

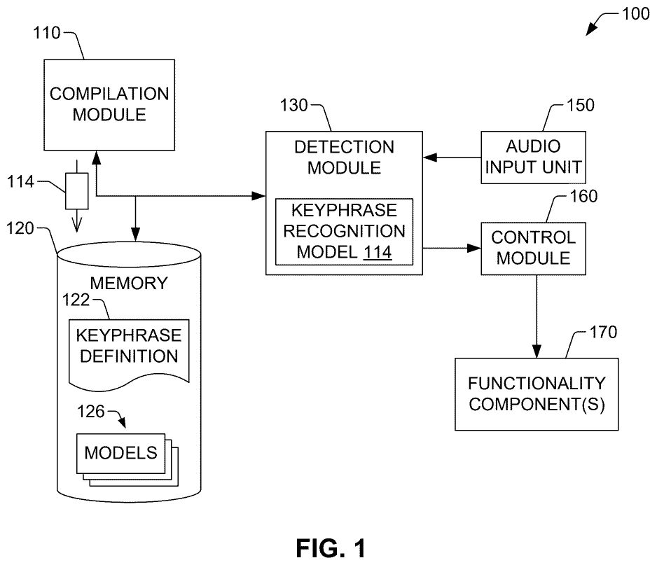

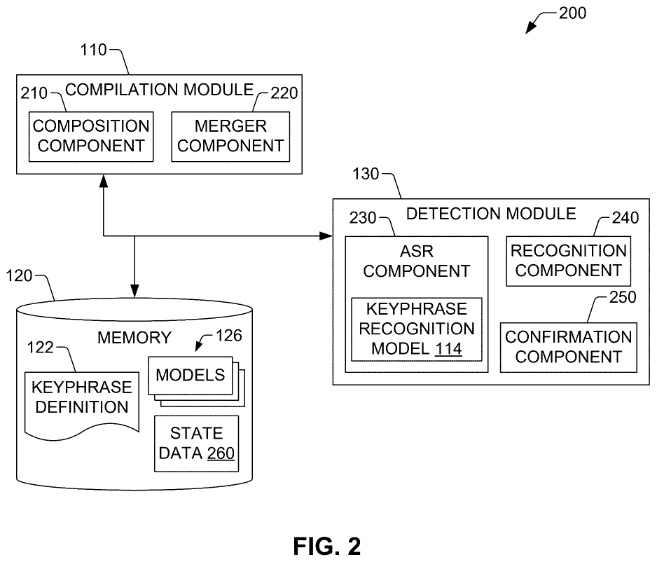

FIG. 1 illustrates an example of a computing system 100 for keyphrase detection, in accordance with one or more aspects of this disclosure. The computing system 100 can include a compilation module 110 that can generate a domain-specific language model based on multiple keyphrases in a natural language (such as, but not limited to, English, German, Spanish, or Portuguese). The domain-specific language model can be a statistical n-gram model. The multiple keyphrases define a language domain where each legal sentence in the language domain corresponds to a respective one of multiple keyphrases. That is, as used herein, a legal sentence is a statement that includes a group of words, a phrase, or a sentence that represents a keyphrase to be recognized. The compilation module 110 can generate probabilities of words in the domain (the unigrams), along with the probabilities that one word follows another word (bi-grams), and continuing up to probabilities that a word follows a sequence of n−1 other words (n-grams). In one example scenario, the multiple keyphrases can consist of two keyphrases: “hello analog” and “open the windows,” each defining a legal sentence. Considering that each of those two legal sentences are equally likely, the compilation module 110 can generate a set of unigrams for each of the words “hello,” “analog,” “open,” “the,” and “windows,” along with bigrams having non-zero probabilities for “analog” if it follows “hello”, and “the” if it follows “open,” and “windows” if it follows “the,” and a trigram probability for “windows” if it follows “open” and “the” in that order. In some aspects, as is illustrated in the computing system 200 in FIG. 2, the compilation module 110 can include a composition component 210 that can generate the domain-specific language model.

To generate the domain-specific language model, the compilation module 110 can access multiple keyphrases. Accessing the multiple keyphrases can include reading a document 122 retained in one or more memory devices 120 (referred to as memory 120) functionally coupled to the compilation module 110. The document 122 can be retained in a filesystem within the memory 120. The document 122 can be a text file that defines the multiple keyphrases. As an example, the multiple keywords can include a combination of two or more of “hello analog,” “open the windows,” “Asterix stop” (e.g., where “Asterix” is a name of a device or robot), “lock the patio door,” “increase gas flow,” “increase temperature,” “shut down,” “turn on the lights,” or “lower the volume.”

In order to prevent biases in the domain-specific language model that is generated, the compilation module 110 can generate one or more prefixes for each keyphrase of the multiple keyphrases that have been accessed. By incorporating prefixes into the domain-specific model, detection may not be biased to recognize a prefix of a keyphrase as the entire keyphrase. For example, in case the multiple keyphrases include “open the window” and “Asterix stop,” the compilation module 110 can generate the following prefixes: “open the” and “open,” and “Asterix.” If “Asterix” is the name of a robot and the “Asterix” prefix is not included in the domain-specific language model, detection may be biased to recognize “Asterix stop” even when simply “Asterix” or “Asterix start” has been uttered. Hence, by including prefixes in the domain-specific language, aspects of this disclosure can readily reduce the incidence of false positives during detection of keyphrases, thus avoiding potentially catastrophic instances of a false positive detection.

Accordingly, the compilation module 110 (via the composition component 210 (FIG. 2), for example) can generate a domain-specific finite state transducer (FST) representing one or more prefixes and each keyphrase of the multiple keyphrases in the keyphrase definition 122. Generating the domain-specific FST results in a domain-specific language model corresponding to the multiple keyphrases.

The domain-specific language model (e.g., a domain-specific statistical n-gram model) by itself may provide limited keyphrase recognition capability. A reason for such potential limitation is that keyphrase detection based on the domain-specific language model alone can result in interpreting any utterance as being one of the legal sentences defined by respective ones of the keyphrases in the keyphrase definition 122. Such an interpretation during keyphrase detection can yield a substantial false positive rate.

Accordingly, the compilation module 110 can merge (via the merger component 220 (FIG. 2), for example) the domain-specific language model with another language model that is based on an ordinary spoken natural language (such as, but not limited to, English or German). That other language model can be a wide-vocabulary statistical n-gram model that can recognize other utterances. Merging such models results in a keyphrase recognition model 114. In one example, the other language model can be a wide-vocabulary FST representing the ordinary spoken natural language. Thus, the keyphrase recognition model 114 can be a FST resulting from merging the domain-specific FST corresponding to the domain-specific model with the wide-vocabulary FST. The merged FST can assign first probabilities to sequences of words corresponding to respective keyphrases, and can assign second probabilities to sequences of words from ordinary speech where the second probabilities are similar to the wide-vocabulary FST for ordinary spoken natural language. The first probabilities can be higher than the second probabilities. Thus, the merged FST can assign a probability to a word in speech that is equal to the product of one of the second probabilities for that word and one of the first probabilities for the keyphrase containing that word. The compilation module 110 can retain the keyphrase recognition model 114 within the memory 120, as part of a group of models 126.

The keyphrase recognition model 114 can be a statistical n-gram model that has a weighting factor indicative of how likely it is that a speaker is speaking one of the keyphrases in the document 122, and how likely it is that the speaker is speaking ordinary speech. As such, the keyphrase recognition model 114 contemplates that a speaker either speaks in ordinary natural language (English, for example) or utters the keyphrases, with a relatively high but not overwhelmingly high probability of using the keyphrases. That is not to say that the speaker need to speak a keyphrase at a particular rate or during a particular portion of speech. Instead, such a probability of using keyphrases as is contemplated by the keyphrase recognition model 114 is an a priori probability that an utterance present in speech is a keyphrase. Such an a priori probability is a configurable parameter, and in some cases, can range from about 0.01 to about 0.30.

As is illustrated in FIG. 1, the computing system 100 can include a detection module 130 that can obtain the keyphrase recognition model 114, and can detect, based on applying the keyphrase recognition model 114 to speech, a particular keyphrase of the multiple keyphrases in the document 122. The detection module 130 can obtain the keyphrase recognition model 114 in several ways. In some cases, the detection module 130 can load the keyphrase recognition model 114 from the memory 120. In other cases, the detection module 130 can receive the keyphrase recognition model 114 from the compilation module 110 or a component functionally coupled thereto (such as an output/report component; not depicted in FIG. 1). In other words, the detection module 130 may be deployed separately from the compilation module 110, such as being located in a completely different device; e.g., a first computing device of the computing system 100 contains the detection module 130 and a second computing device of the computing system 100 contains the compilation module 110. Regarding speech, the detection module 130 can receive an audio signal representative of speech or ambient audio, or both. The audio signal can be received by means of an audio input unit 150, for example. The audio signal can represent audible audio that is external to a computing device that hosts the detection module 130 and/or the audio input unit 150. The audio input unit 150 can include a microphone (e.g., a microelectromechanical (MEMS) microphone), analog-to-digital converter(s), amplifier(s), filter(s), and/or other circuitry for processing of audio. The microphone can receive the audible audio constituting an external audio signal representing the speech or the ambient audio, or both. The audio input unit 150 can send the external audio signal to the detection module 130 and/or another component included in the computing device.

As is illustrated in FIG. 2, the detection module 130 can include an ASR component 230 that can apply a keyphrase recognition model 114 to speech. The ASR component 230 can apply the keyphrase recognition model 114 by determining phonemes present within speech, and then determining, using the phonemes and the keyphrase recognition model 114, a most probable sequence of words (e.g., a phrase or sentence). The ASR component 230 can use a trained ML model to determine the phonemes. The trained ML model can be a trained neural network, for example. In cases where the ASR component 230 processes ambient audio, the ASR component 230 may not determine phonemes and can thus identify that a pause in speech has occurred. The ASR component 230 can update state data 260 to indicate that a pause in speech for a predetermined period of time, e.g., a long pause, has occurred. Here, a long pause refers to a period of time that separates sentences in speech, and can be longer than another period of time that separates spoken words within a sentence. That period of time defining a long pause is a configurable quantity. Examples of a long pause include 350 ms, 384 ms, and 400 ms.

The ASR component 230 can periodically determine a sequence of words by applying the keyphrase recognition model 114 to speech. Hence, the ASR component 230 can determine a sequence of words at consecutive time intervals spanning a same defined time period. The sequence of words that has been determined at a time interval corresponds to words that may have been spoken since a last long pause in speech. Accordingly, at each time interval, the ASR component 230 can update the words that may have been spoken since the last long pause. Each one of the time intervals, or the defined time period, can be referred to as a “tick.” Examples of the defined time period include 64 ms, 100 ms, 128 ms, 150 ms, 200 ms, 256 ms, and 300 ms. This disclosure is not limited in that respect, and longer or shorter ticks can be defined. It is noted that the long pause referred to hereinbefore can be defined as two or more ticks.

A sequence of words determined in a tick is referred to as a partial recognition. A final recognition refers to the immediately past sequence of words that has been determined before the ASR component 230 has identified a long pause. Accordingly, the ASR component 230 can determine a series of one or more partial recognitions before determining a final recognition. The ASR component 230 can update state data 260 within the memory 120 to indicate that a recognition is a final recognition. For example, the state data 260 can represent, among other things, a Boolean variable indicating if a recognition is final. The ASR component 230 can update the Boolean variable to “true” (or another value indicative of truth), in response to a recognition that is final.

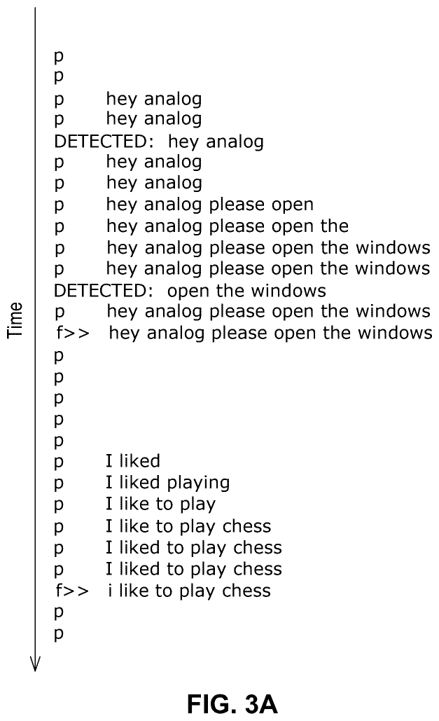

FIG. 3A illustrates an example of partial and final recognitions when a speaker utters “hey analog, please open the windows” and then “I like to play chess.” The “p” at the beginning of some lines indicates that the ASR component 230 emitted a partial recognition of a sequence of words received since the last final recognition. The “f>>” at the beginning of some lines indicates that the ASR component 230 indicated that such a recognition is a final recognition of a sequence of words followed by a pause. It is noted that the ASR component 230 may revise partial recognitions at later instants of time. For example, as is shown in FIG. 3A, the ASR component 230 can initially report “I liked playing” before changing to report “I like to play chess.” These types of changes can often occur as the probabilities change when more speech is processed and the overall probability changes based on the keyphrase recognition model 114 and the phonemes that are determined by the ASR component 230.

With further reference to FIG. 1, the detection module 130 can use both partial recognitions and final recognitions in order to achieve responsive low-latency detection of keyphrases. Relying exclusively on a final recognition may hinder responsiveness, particularly in situations where the speech being processed spans a long time (e.g., a few to several seconds). Regardless of the type of recognition, the detection module 130 can detect a keyphrase in response to determining that a suffix of a sequence of words pertaining to the recognition includes the keyphrase. In some aspects, the detection module 130 can include a recognition component 240 (FIG. 2) that can determine presence or absence of a keyphrase in a suffix of the recognition. Determining presence of the keyphrase in the suffix indicates that the keyphrase has been recognized. Such a determination represents a preliminary detection of the keyphrase. For example, in case the ASR component 230 determines the sequence of words “what a fabulous day let's open the windows” in a first tick, the recognition component 240 can determine that the suffix corresponds to the keyphrase “open the windows,” and therefore a preliminary detection of “open the windows” occurs.

The multiple keyphrases defined in the document 122 can be configured with respective parameters (or another type of data) that indicate a desired latency to use in the detection of each keyphrase. Such parameters (or data) also can be defined in the document 122. For example, the document 122 can be a tab-separated value (TSV) file or comma-separated value (CSV) file, where each line has a field including a latency parameter (e.g., “4” indicating four ticks) and another field including a keyphrase (e.g., “hey analog”). In some cases, at least one keyphrase of the multiple keyphrases can be configured with respective parameters (or data) indicative of zero latency. In other cases, at least one of a second keyphrase of the multiple keyphrases can be configured with respective parameters (or data) indicative of non-zero latency.

A non-zero latency parameter (or datum) defines an intervening time period between a first preliminary detection of a keyphrase and a second preliminary detection of the keyphrase. The second preliminary detection can be referred to as confirmation detection, and is a subsequent recognition that occurs immediately after the intervening time period has elapsed. The intervening time period can thus be referred to as confirmation period, and that subsequent recognition can be referred to as confirmation detection. A preliminary detection of a particular keyphrase followed by a confirmation detection of the particular keyphrase yields a keyphrase detection of the particular keyphrase. The non-zero latency parameter can define the intervening time period as a multiple N_{L} of a tick. Here, N_{L} is a natural number equal to or greater than 1. Thus, a non-zero latency parameter can cause the detection module 130 to wait N_{L} ticks before recognizing the particular keyphrase at a time interval corresponding to the N_{L}+1 tick, and thus arriving at the confirmation detection. For example, the document 122 can configure a zero latency for a first keyphrase (e.g., “stop now”), a non-zero latency of one tick for a second keyphrase (e.g., “move forward”), and a non-zero latency of two ticks for a third keyphrase (e.g., “wake up”). Hence, not only can the detection module 130 flexibly detect different keyphrases, but it can detect the different keyphrases according to respective defined latencies. Such flexibility is an improvement over commonplace technology for keyphrase detection.

Because at each tick the ASR component 230 (FIG. 2) can update the sequence of words that has been recognized at the tick, the configuration of latency for keyphrases to be detected in speech can permit controlling a rate of false positives in the detection of a keyphrase. In scenarios where a low false-positive rate is desired (as it might be the case for wakeup phrases) N_{L} can be configured to 2, for example, causing the detection module 130 to wait two ticks for confirmation. In other scenarios where substantial low latency is desired and a greater rate of false positive may be tolerated, N_{L} can be set to zero. For example, zero latency can be configured for keyphrase indicative of a time-sensitive shutdown command.

Accordingly, to detect a particular keyphrase defined in the document 122, the detection module 130 can determine, using the keyphrase recognition model 114, a sequence of words within speech during a first time interval. The first time interval can span a tick (e.g., 128 ms). The detection module 130 can determine the sequence of words by means of the ASR component 230 (FIG. 2). The detection module 130 can then determine, via the recognition component 240 (FIG. 2), that a suffix of the sequence of words corresponds to the particular keyphrase. Determining such a suffix indicates that the particular keyword has been recognized and constitutes a preliminary detection. The detection module 130 can determine if the particular keyphrase is associated with a non-zero latency parameter. To that end, in some configurations, the detection module 130 can obtain a parameter indicative of latency for the particular keyphrase. That parameter can be obtained from the document 122. Determining that the particular keyphrase is associated with zero latency can cause the detection module 130 to configure the preliminary detection as a confirmation detection. The detection module 130 can include a confirmation component 250 (FIG. 2) that can generate confirmation data indicative of the particular keyphrase being present in the speech in the first time interval. In addition, the confirmation component 250 can update state data 260 (FIG. 2) to indicate that the particular keyphrase has been detected in the speech during the first time interval. The state data 260 can define a state variable for the particular keyphrase, and updating the state data can include updating the state variable to a value indicating that the particular keyphrase has been detected in the sequence of words associated with the first time interval.

Determining that the particular keyphrase is associated with a non-zero latency parameter can cause the detection module 130 to update state data 260 (FIG. 2) to indicate that the particular keyphrase has been recognized in the speech during the first time interval. The state data 260 can define a state variable for the particular keyphrase, and updating the state data can include updating the state variable to a first value indicating that the particular keyphrase has been recognized in the speech during the first time interval, but is not yet confirmed. The confirmation component 250 can update the state data 260 in such a fashion. Additionally, the non-zero latency parameter can cause the recognition component 240 to wait until a confirmation period has elapsed, while the ASR component 230 continues to recognize words spoken near a computing device that hosts the detection module 130.

In order to confirm the preliminary detection of the particular keyword that occurred in the first time interval, the detection module 130 can determine, using the keyphrase recognition model 114, respective second sequences of words within speech during each time interval in a series of consecutive second time intervals (e.g., consecutive ticks). The series of consecutive second time intervals begins immediately after the first time interval has elapsed and spans the confirmation period. The detection module 130 can determine the respective second sequences of words using the ASR component 230 (FIG. 2). In some cases, the detection module 130 can determine that a suffix of each one of the respective second sequences of words corresponds to the particular keyphrase that has been detected in the preliminary detection. In other words, the detection module 130 can determine consecutive subsequent recognitions of the particular keyphrase during the confirmation period. Accordingly, the detection module 130 can generate confirmation data indicative of the particular keyphrase being present in speech in a second time interval after the first time interval. In addition, the detection module 130 can update the state data 260 (FIG. 2) to indicate that the particular keyphrase has been detected, e.g., recognized and confirmed, after the confirmation period has elapsed. As is described herein, the state data can define a state variable for the particular keyphrase, and updating the state data 260 can include updating the state variable to a value indicating that the particular keyphrase has been detected in a second sequence of words associated with the second time interval. The confirmation component 250 (FIG. 2) can update the state data 260 in such a fashion.

In some cases, the ASR component 230 (FIG. 2) determines a final recognition of a sequence of words that has a particular keyphrase in a suffix of the sequence. In such cases, the detection module 130 can determine that the keyphrase has been detected, e.g., recognized and confirmed, regardless of latency associated with the particular keyphrase, FIG. 3B illustrates an example scenario where a N_{L}=4 is configured for both “hey analog” and “open the window.” A final recognition is determined prior to four ticks elapsing, and still a detection of “open the window” occurs (see “DETECTED” entry 310 in FIG. 3B).

Although aspects of the disclosure are illustrated with reference to keyphrases that define a language domain, the disclosure is not limited in that respect. The principles and practical applications of this disclosure can be extended to detection of any defined sequence of words, any phrase or sentence, that is sanctioned or otherwise accepted by a grammar, such as a context-free grammar. To that end, the computing system 100 (FIG. 1) can include a high-speed parser component that can operate on suffixes of each recognition, to determine if a suffix is a defined phrase or sentence sanctioned by the grammar. Once the defined phrase or sentence is determined, the detection module 130 (via the recognition component 240, for example) can confirm the recognition of that defined phrase or sentence at a subsequent time interval (e.g., a tick) by determining if the defined phrase was contained within a partial recognition or a final recognition.

The detection of particular keyphrases has practical applications. For example, detecting a particular keyphrase can cause a computing device or another type of apparatus to perform a task or a group of tasks associated with the particular keyphrase. In some cases, in response to detecting the particular keyphrase, the detection module 130 can cause at least one functional component or a subsystem to execute one or more operations (e.g., control operations) associated with the particular keyphrase. Such operation(s) define a task. In one example, as is illustrated in FIG. 1, the detection module 130 can direct a control module 160 to cause one or more functionality components 170 to perform a specific task in response to detecting a particular keyphrase (e.g., “open the windows” or “unlock the door”).

Depending on the functionality of an apparatus that includes the functionality component(s) 170, the functionality component(s) 170 can include particular types of hardware or equipment. As an example, the functionality component(s) 170 can include a loudspeaker, a microphone, a camera device, a motorized brushing assembly, a robotic arm, sensor devices, power locks, motorized conveyor belts, or similar. In some cases, the functionality component(s) 170 include various hardware or equipment that can be separated into multiple subsystems. One or more of the multiple subsystems can include separate groups of functional elements. Simply as an illustration, in automotive applications, the multiple subsystems can include an in-vehicle infotainment subsystem, a temperature control subsystem, and a lighting subsystem. The infotainment subsystem can include a display device and associated components, a group of audio devices (loudspeakers, microphones, etc.), a radio tuner or a radio module including the radio tuner, or the like.

To cause the functionality component(s) 170 to perform the specific task, the control module 160 can then send an instruction to perform the specific task. The instruction can be formatted or otherwise configured to according to a control protocol for operation of equipment or other hardware that performs the task or is involved in performing the task. Depending on architecture of the functionality component(s) 170, the instruction can be formatted or otherwise configured according to a control protocol for the operation of a loudspeaker, an actuator, a switch, motors, a fan, a fluid pump, a vacuum pump, a current source device, an amplifier device, a combination thereof, or the like. The control protocol can include, for example, modbus; Ethernet-based industrial protocol (e.g., Ethernet TCP/IP encapsulated with modbus); controller area network (CAN) protocol; profibus protocol; and/or other types of fieldbus protocols.

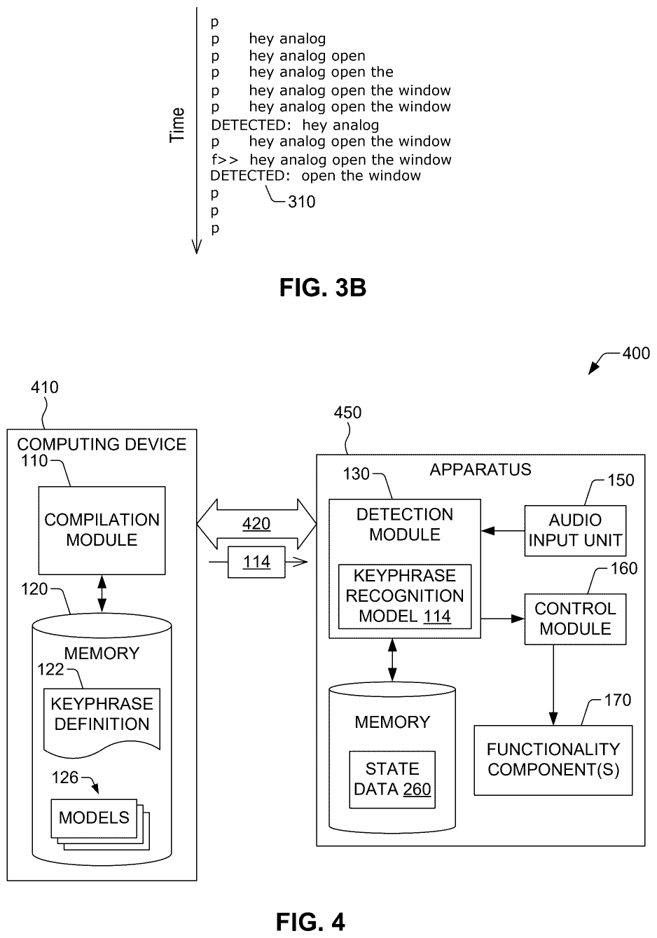

The example computing system 100 illustrated in FIG. 1 can be implemented in various ways. Simply for purposes of illustration, FIG. 4 is a block diagram of an example of a computing system where generation of a keyphrase recognition model is separate from application of the keyphrase recognition model to detection of keyphrases and related practical applications. An example of the practical applications is control of the operation of an apparatus. The example computing system 400 that is illustrated in FIG. 4 includes a computing device 410 that hosts the compilation module 110, and can generate the keyphrase recognition model 114 in accordance with aspects described herein.

The computing system 400 also includes an apparatus 450 that can host the detection module 130. The apparatus 450 can detect keyphrases by applying the keyphrase recognition model 114 to speech that may be received at the apparatus 450, via the audio input unit 150, in accordance with aspects described herein. The apparatus 450 can receive or otherwise obtain the keyphrase recognition model 114 from the computing device 410 or another device functionally coupled thereto (not depicted in FIG. 4). In an example scenario, the apparatus 450 can receive the keyphrase recognition model at factory during production of the apparatus 450. In another example scenario, the apparatus can receive the keyphrase recognition model in the field, as part of a configuration stage (an initialization stage or an update stage, for example) of the apparatus 450. In some cases, the apparatus 450 can receive the keyphrase recognition model 114 via a communication architecture 420 that functionally couples the computing device 410 and the apparatus 450. The communication architecture 420 can permit wired communication and/or wireless communication. The apparatus 450 can perform one or more tasks in response to detecting a particular keyphrase or a sequence of particular keyphrases. The apparatus 450 (and other apparatuses in accordance with aspects of this disclosure) can include various computing resources (not all resources depicted in FIG. 4) and also can be referred to as a computing device. Computing resources can include, for example, a combination of (A) one or multiple processors, (B) one or multiple memory devices, (C) one or multiple input/output interfaces, including network interfaces (wireless or otherwise); or similar resources. Similarly, a computing device embodies, or constitutes, an apparatus (or machine).

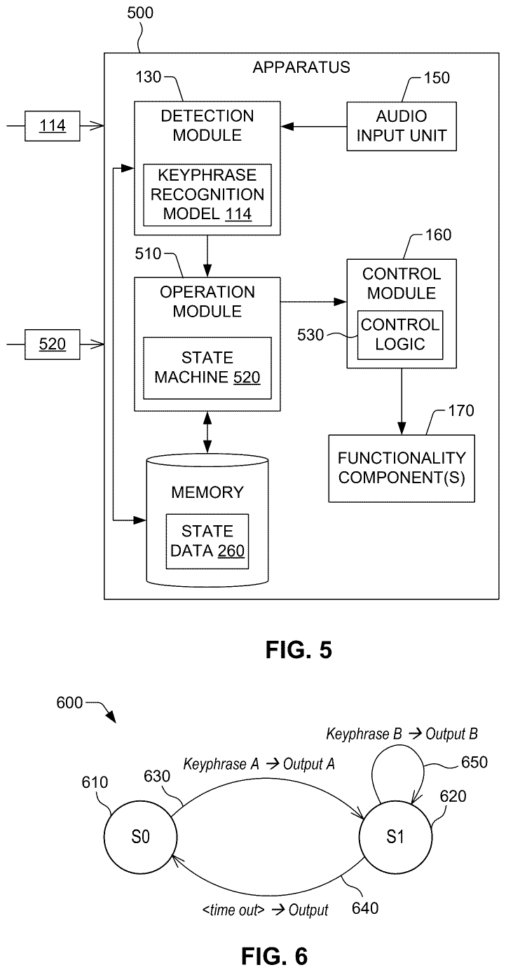

FIG. 5 is a block diagram of an example of an apparatus for keyphrase detection and related practical applications, in accordance with one or more aspects of this disclosure. The apparatus 500 that is exemplified in FIG. 5 is a variant of the apparatus 450 illustrated in FIG. 4. Accordingly, the apparatus 500 includes at least some of the functional elements of the apparatus 450, and also includes an operation module 510. The apparatus 500 can include various computing resources and also can be referred to as a computing device. Additionally, in some cases, the apparatus 500 can substitute the apparatus 450 within the example system 400 (FIG. 4). Further, in other cases, the apparatus 500 can be another apparatus that forms part of the example system 400 (FIG. 4) in addition to the apparatus 450. In cases where the apparatus 500 also is present in the example system 400, the communication architecture 420 can functionally coupled the apparatus 500 with the computing device 410 and the apparatus 450.

As is illustrated in FIG. 5, the apparatus 500 hosts the detection module 130. Additionally, the apparatus 500 can detect keyphrases by applying the keyphrase recognition model 114 to speech that may be received at the apparatus 500, via the audio input unit 150, in accordance with aspects described herein. Further, the apparatus 500 can receive or otherwise obtain the keyphrase recognition model 114 from the computing device 410 (FIG. 4) or another device functionally coupled to the apparatus 500. As is described herein, in an example scenario, the apparatus 500 can receive the keyphrase recognition model 114 at factory during production of the apparatus 450. In another example scenario, the apparatus 500 can receive the keyphrase recognition model 114 in the field, as part of a configuration stage (an initialization stage or an update stage, for example) of the apparatus 450.

The operation module 510 can cause the apparatus 500 to perform one or more tasks in response to detecting a particular keyphrase or a sequence of particular keyphrases. To that end, in response to a particular keyphrase being detected, the operation module 510 can cause the control module 160 to direct or otherwise control the operation of the functionality component(s) 170. Controlling the operation of the functionality component(s) 170 includes directing at least one of the functionality component(s) 170 to perform the task(s). Although the functionality component(s) 170 are shown are being includes in the apparatus 500, the disclosure is not limited in this respect. Indeed, a portion or the entirety of the functionality component(s) 170 may be external to apparatus 500.

To cause the apparatus 500 to perform a task or a sequence of tasks, the operation module 510 can implement a state machine 520. The state machine 520 is defined by multiple states and multiple state transitions, where each state transition is caused by a respective event. In response to an event, a state transition causes the state machine 520 either (i) to change the state of the state machine 520 from a current state to a next state or (ii) to remain in the current state of the state machine 520. The state machine 520 also can be further defined by respective output data provided in response to the multiple state transitions. That is, a first state transition causes the state machine 520 to provide a first output data, and a second state transition causes the state machine 520 to provide a second output data.

The operation module 510, in response to implementing the state machine 520, can provide the first output data and the second output data to the control module 160. The control module 160 can execute control logic 530 that is based, at least partially, on the first output data and the second output data. In response to executing the control logic 530 and receiving the first output data and/or the second output data, the control module 160 causes the apparatus 450 to perform a task or a sequence of tasks.

The state machine 520 can be represented by a graph having multiple nodes representing respective ones of multiple states, and also having multiple edges representing respective ones of the multiple state transitions. Each node can be identified with a respective unique identifier, such as natural number. Each edge can be defined by a respective statement according to the following edge syntax:

| | | | | |
|---|---|---|---|---|
| Current_State | Next_State | Event | Response | ResetTimeout. |

In the edge syntax, Current_State is a unique identifier indicative of the first state at which the edge originates, and Next_State is a unique identifier indicative of a second state at which the edge ends. Thus, the ordered combination Current_State, Next_State indicates a transition from the first state to the second state. Further, Event defines the input event that causes the transition, and Response represents output data that the state machine 520 can supply in response to the transition.

For some edges, the input event is the detection of a particular keyphrase and the output data correspond to the particular keyphrase. The detection module 130 (FIG. 5) detects the particular keyphrase as is described herein. In other configurations, the output data can be indicative of information other than the particular keyphrase. For instance, the output data can correspond to, or can define, one or more wakeup phrases or other keyphrase(s) besides the particular keyphrase. More specifically, in one example, the particular keyphrase is “open the trunk” and the output data is indicative of the phrase “open trunk.” In another example, the particular keyphrase is “open the trunk” and the output data is indicative of a translation of that particular phrase into another natural language. For other edges, the input event is expiration of a defined time interval since a last transition into the current state. In other words, the defined time interval can be a time-to-live (TTL) for the current node, after which TTL the current node transitions to another node. The output data provided in response to the expiration of the defined time interval can be void output data. That is, the state machine 520 does not provide any output data in response to the expiration of the defined time interval. Furthermore, ResetTimeout is an optional field that when set to a defined value (e.g., 1) indicates that a TTL timer is reset after a self-transition.

The state machine 520 can be defined or otherwise configured, at least partially, by a listing of statements defining a graph that represents the state machine 520. Listing of statements can retained in a document that can be retained in a filesystem within one or more memory devices or other type of processor-accessible non-transitory storage media. The document can be a text file that defines the listing of statements. In an example scenario, the document can be retained in the memory 120 of the computing device 410 (not depicted in FIG. 5).

The listing of statements defining the graph that represents the state machine 520 includes a first group of statements defining respective input events. Each one of the respective input events causes a state transition in the state machine 520. Each event in the first group of statements corresponds to detection of a respective particular keyphrase. Thus, each statement in the first group of statements defines the respective particular keyphrase. For example, a first statement can be “hey analog” and a second statement can be “lock the door.” Accordingly, an event syntax defining an input event can be A_Keyphrase, where the field A_Keyphrase represents both a particular keyphrase and detection of that particular keyphrase. The operation module 510 interprets the A_Keyphrase field as detection of the particular keyphrase.

The listing of statements defining the graph that represents the state machine 520 also includes a statement defining a set of two or more states (nodes) corresponding to the state machine 520. The statement can be a series of comma-separated fields, each field containing a unique identifier (e.g., a unique natural number) that identifies a respective state. Such a statement can thus have the following syntax: S₁, S₂, . . . S_{N-1}, S_{M}. Here, M represents the number of states present in the state machine 520, and S_{λ} represents a unique identifier for state (or node) λ, where λ=1, 2, . . . M. Hence, a listing of statements defining an example state machine 520 that has M=5 states includes the following statement: S1, S2, S3, S4, S5. The disclosure is not limited to a format involving comma-separated fields, nor is it limited to a single statement defining the set of two or more states corresponding to the state machine 520.

The listing of statements defining the graph that represents the state machine 520 further includes a second group of statements defining respective edges in such a graph. Each statement in the second group obeys the event syntax described above.

The apparatus 500 can obtain the list of statements defining the state machine 520 from a computing device or another type of apparatus that is external to the apparatus 500. Obtaining the state machine 520 thus includes receiving such a listing of statements. In some cases, the listing of statements can be received individually. In this fashion, an existing state machine within the apparatus 500 can be updated incrementally, resulting in configuration of the state machine 520. In other cases, the listing of statement can be received collectively, by reading the document that defines the listing of statements from a filesystem in the computing device or the other type of apparatus. In one example, the computing device is or includes the computing device 410.

The state machine 520 includes a first state and a second state. As is described herein, a first input event that causes a transition from the first state to the second state can be the detection of a particular keyphrase of the multiple keyphases associated with the keyphrase recognition model 114. For example, the particular keyphrase can be a wakeup phrase (e.g., “hey analog”). A transition between different states can be referred to as an inter-state transition, simply for the sake of nomenclature. As part of implementing the state machine 520, the operation module 510 can determine that the particular keyphrase corresponding to the first input event has been detected. In response, the operation module 510 can transition the state machine from the first state to the second state. Also as part of implementing the state machine 520, the operation module 510 can provide first output data to the control module 160 in response to the transition from the first state to the second state. In some cases, the particular keyphrase can constitute the first output data, and, thus, the operation module 510 can provide the particular keyphrase to the control module 160. In other cases, a defined keyphrase can constitute the first output data, and, thus, the operation module 510 can provide the defined keyphrase to the control module 160. The defined keyphrase is distinct from the particular keyphrase. In response to executing the control logic 530 and receiving the particular keyphrase or, in some cases, the defined keyphrase, the control module 160 can cause the apparatus 500 to execute a control operation associated with the particular keyphrase or, in some cases, the defined keyphrase. In an example configuration in which the particular keyphrase is a wakeup phrase and the output data is indicative of the particular keyphrase, the control operation that is executed can be energizing one or more of the functionality component(s) 170.

Further, in some cases, the state machine 520 can be configured to cause a transition from the second state to the second state—what is referred to as a self-transition—in response to a second input event. The second input event that causes such a self-transition can be the detection of a second particular keyphrase of the multiple keyphases associated with the keyphrase recognition model 114. For example, the second particular keyphrase can be a command phrase (e.g., “open the window”). As part of continuing implementing the state machine 520, the operation module 510 can determine that the second particular keyphrase corresponding to the second input event has been detected. In response, the operation module 510 can transition the state machine from the second state to the second state itself. Also as part of implementing the state machine 520, the operation module 510 can provide second output data to the control module 160 in response to that self-transition. In some cases, the second particular keyphrase can constitute the second output data, and, thus, the operation module 510 can provide the second particular keyphrase to the control module 160. In other cases, another defined keyphrase can constitute the second output data, and, thus, the operation module 510 can provide that other defined keyphrase to the control module 160. The other defined keyphrase is distinct from the second particular keyphrase. In response to executing the control logic 530 and receiving the second particular keyphrase or, in some cases, the other defined keyphrase, the control module 160 can cause the apparatus 500 to execute a control operation associated with the second keyphrase or, in some cases, the defined keyphrase. In an example configuration in which the second particular keyphrase is the command phrase and the second output data is indicative of the second particular keyphrase, the control operation that is executed includes an action or sequence of actions corresponding to the command defined by the command phrase.

Accordingly, in some cases, as a result of implementing the state machine 520, the operation module 510 cause the apparatus 500 to perform a sequence of tasks involving energizing one or more of the functionality component(s) 170 and then executing an action or sequence of actions corresponding to a defined command.

Because of the configurable output data included in the state machine 520, in response to being applied, the state machine 520 can serve as a filter of keyphrases. Thus, a keyphrase recognition model based on a large set of keyphrases can be configured for several types of apparatuses with different functionality, and control of a particular type of the apparatuses can be made specific via the application of the state machine 520. Simply for purposes of illustration, a large set of keyphrases can include tens, hundreds, or even thousands of keyphrases.

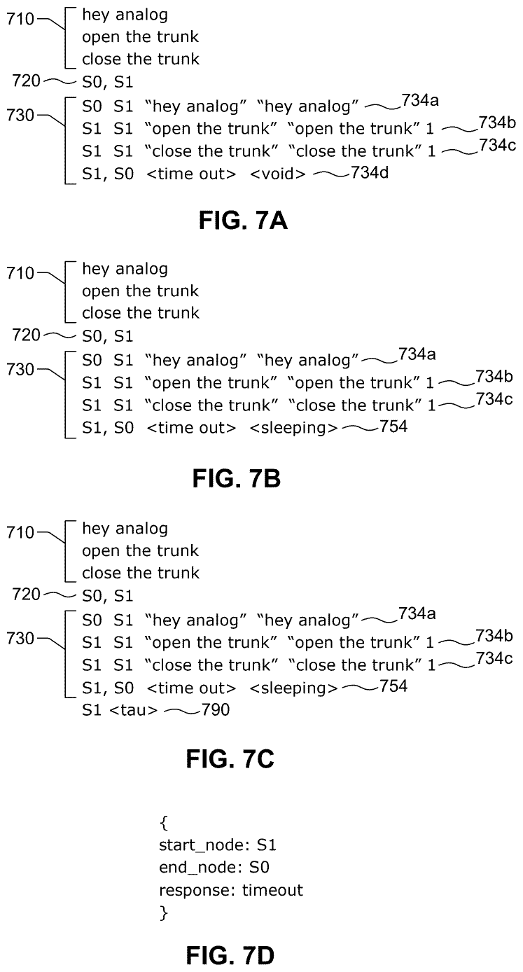

Simply as an illustration, FIG. 6 is a graph 600 that represents an example of the state machine 520, in accordance with aspects of this disclosure. In the example, the graph 600 has a first node 610 and a second node 620 corresponding, respectively, to a first state and a second state of the state machine 520. The first node 610 is labeled “S0,” simply for the sake of nomenclature. The label S0 represents a unique natural number associated with that node. The second node 620 is labeled “S1,” again simply for the sake of nomenclature, where S1 represents a unique natural number associated with that node. Further, in the example, the state machine 520 also has multiple edges, including a first edge 630, a second edge 640, and a third edge 650. The first edge 630 represents a transition from the first node 610 to the second node 620. The first edge 630 is defined in terms of an Event corresponding to a Keyphrase A, and a Response representing defined output data. The Event and Response fields are those introduced in the edge syntax above. As is shown in the graph 600, the first edge 630 is labeled as “Keyphrase A→Output A” as a depiction of the event that caused the transition and the output data that the example state machine 520 outputs in response to the transition. In one example, the Keyphrase A is a wakeup phrase, such as “hey analog” or “wakey wakey.”

The second edge 640 in the graph 600 represents a transition from the second node 620 to the first node 610. The second edge 640 is defined in terms of an Event corresponding to the expiration of a TTL for the node 620, and a Response representing output data (either defined information or a void datum). Again, the Event and Response fields are those introduced in the edge syntax above. As is shown in the graph 600, the second edge 640 is labeled as “<time out>→Output” as a depiction of the event that caused the transition and the output data that the example state machine 520 outputs in response to the transition. Here, <time out> represents the expiration of a TTL for a node. In some cases, Output denotes void output data (which can be represented by “<void>”).

The third edge 650 in the graph 600 represents a self-transition from the second node 620 to itself. The third edge 650 is defined in terms of an Event corresponding to a Keyphrase B, and a Response representing defined output data. As mentioned, the Event and Response fields are those introduced in the edge syntax above. As is shown in the graph 600, the third edge 650 is labeled as “Keyphrase B→Output B” as a depiction of the event that caused the transition and the output data that the example state machine 520 outputs in response to the transition. In one example, the Keyphrase B is a command or another type of instruction, such as “open the trunk,” “close the trunk,” “start engine,” or the like. It is noted that this disclosure is not limited to a single self-transition. Indeed, in some cases, two or more self-transitions (and respective edges) can be defined for the state machine 520.

The graph 600 and any other graph representing the state machine 520 can be defined or otherwise configured by a listing of statements, each statement defining an input event, a set of nodes in the graph, or an edge in the graph. The listing of statements can be retained a memory device of the apparatus 500.

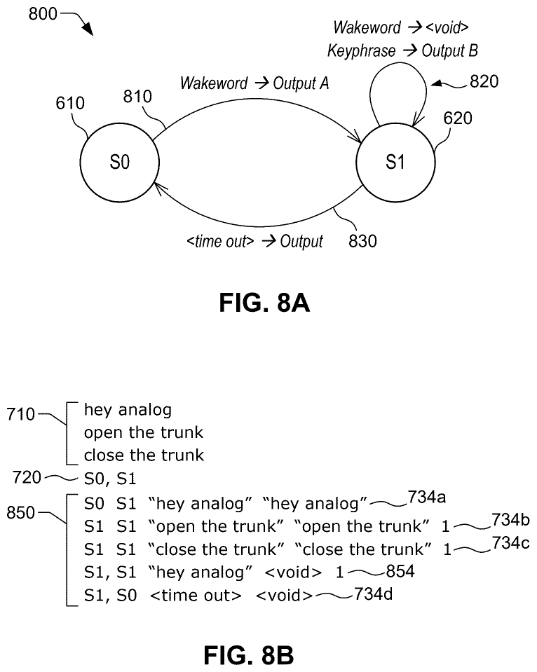

FIG. 7A is a listing of statements that configures an example state machine 520, in accordance with one or more aspects of this disclosure. The listing of statements includes a first group of statements 710 including keyphrases. Each one of the keyphrases defines an event that causes a state transition in the example state machine 520. Detection of a particular keyphrase in that group causes a particular state transition in the example state machine 520. The keyphrases include a wakeup phrase (“hey analog”), a first command (“open the trunk”), and a second command (“close the trunk”). The listing of statements also includes a statement 720 defining a first state and a second state. The first state and the second state are denoted, respectively, by “S0” and “S1,” where S0 represents a first unique identifier and S1 represents a second unique identifier. As is described herein, the first unique identifier and the second unique identifier identify respective nodes in a graph representative of the example state machine 520.

The listing of statements further includes a second group of statements 730 defining respective edges in such a graph. Specifically, a first statement 734b in the second group of statements 730 defines a first edge corresponding to a transition from S0 to S1 in response to detection of a first keyphrase. The first statement also defines that the transition from S0 to S1 causes the example state machine 520 to output the first keyphrase.

A second statement 734b in the second group of statements 730 defines a second edge corresponding to a self-transition for S1 in response to detection of a second keyphrase. The second statement also defines that the self-transition causes the example state machine 520 to output the second keyphrase. A third statement 734c in the second group of statements 730 defines a third edge corresponding to another self-transition for S1 in response to detection of a third keyphrase. The third statement also defines that the self-transition causes the example state machine 520 to output the third keyphrase. According to the second statement and the third statement, none of the self-transitions in S1 cause the output of the first keyphrase. Additionally, because ResetTimout field is set to “1” in the second and third statements, the a TTL timer for S1 is reset in response to individually detecting the second keyphrase and the third keyphrase.

A fourth statement 734d in the second group of statements 730 defines a fourth edge corresponding to a transition from S1 to S0 in response to a <time out> event—that is, expiration of a TTL timer for S1. The fourth statement also defines that the transition from S1 to S0 does not output any data, as is indicated by <void> in that statement.

As is described herein, in some cases, the state machine 520 can output timeout information associated with the expiration of the TTL of a node. For example, the timeout information can convey that a device, another type of apparatus, or a functionality component (e.g., one of functionality component(s) 170) has been inactive for a time interval corresponding to the TTL of the node. The timeout information is defined by the Response field in an edge statement defining <time out> as an input event. Simply as an illustration, FIG. 7B is a listing of statements that configures an example state machine 520, in accordance with one or more aspects of this disclosure. The listing of statements is essentially the same as the listing of statements illustrated in FIG. 7A, except for a statement 754 that defines an edge corresponding to a transition from S1 to S0 in response to a <time out> event, where such a transition causes the example state machine to output timeout information (indicated by <sleeping> in the statement 754). The operation module 510 can format the timeout information in numerous ways, in response to identifying the tag <sleeping> during the implementation of the example state machine 520. In some cases, the timeout information is formatted as a string indicative of the node transition to idle. For example, the string can be “transitioning to idle” or “sleeping.” In other cases, the timeout information is formatted as a data structure indicative of the node transition to idle. An example of the data structure is shown in FIG. 7D. Regardless of its format, the control module 160 can use the timeout information according to the control logic 530.

The time interval that defines the extent of the TTL of a node in the state machine 520 is a configurable attribute of the node. Such a time interval can be configured by a statement according to the following syntax: Node Tau. Here, the Node field is a unique identifier (e.g., a unique natural number) that identifies a node, and the Tau field defines the time interval in a particular unit of time (e.g., seconds) for the node identified by the Node field. In the absence of a statement including Node and Tau fields, the time interval that defines the extent of the TTL of a node is set to a default value (e.g., 4 s, 5 s, or 6 s). In other cases, absence of such a statement indicates that the node lacks a TTL, and, thus, the state machine 520 can remain indefinitely in the state corresponding to the node.

Simply as an illustration, FIG. 7C is a listing of statements that configures an example state machine 520 having a node with a particular TTL, in accordance with one or more aspects of this disclosure. The listing of statements is essentially the same as the listing of statements illustrated in FIG. 7B, except for a statement 790 that defines the time interval that specifies the extent of the TTL of S1. In the statement 790, <tau> denotes a particular amount of time expressed in a particular time unit. For example, <tau> can be 2.5 s.

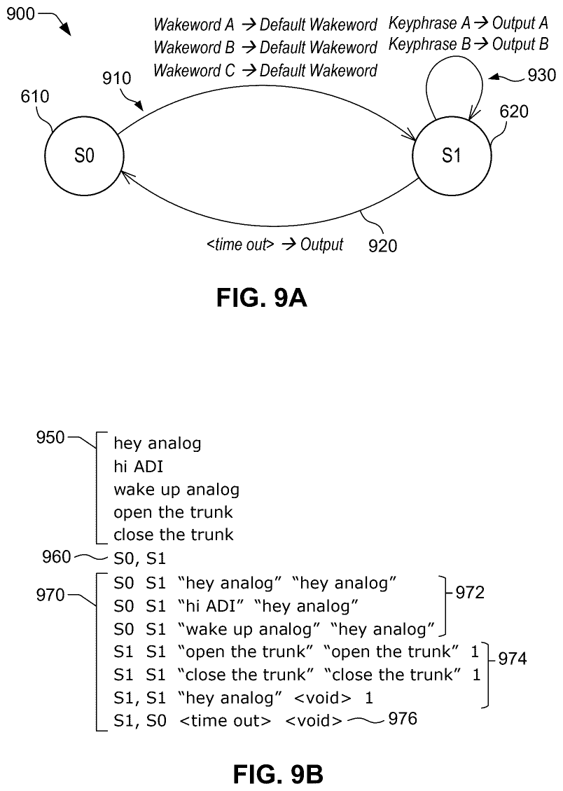

In accordance with aspects of this disclosure, a self-transition can be used to add functionality to a repeat detection of a wakeup phrase (e.g., “hey analog” or “hi ADI”). Simply as an illustration, FIG. 8A is a graph 800 that represents an example of the state machine 520, where repeat detection of a wakeup phrase (denoted by “Wakeword” in FIG. 8A) causes a reset of a TTL timer for the state S1 represented by the node 620. The graph 800 includes the first node 610 and the second node 620 corresponding, respectively, to a first state and a second state of the example state machine 520. Further, the graph 800 has multiple edges, including a first edge 810, a second edge 830, and third edges 820. The first edge 810 represents a transition from the first node 610 to the second node 620. The first edge 810 is defined in terms of an Event corresponding to the wakeup phrase and a Response representing defined output data. As mentioned, the wakeup phrase is denoted by Wakeword in FIG. 8A. Examples of the wakeup phrase include “hey analog,” “hi ADI,” or “wakey wakey.” The Event and Response fields are those introduced in the edge syntax above. As is shown in the graph 800, the first edge 810 is labeled as “Wakeword→Output A” as a depiction of the event that caused the transition and the output data that the example state machine 520 outputs in response to the transition.

The second edge 830 in the graph 800 represents a transition from the second node 620 to the first node 610. The second edge 830 is defined, at least partially, in terms of an Event corresponding to the expiration of a TTL for the second node 620, and a Response representing output data. The output data (either defined information or a void datum) is denoted by Output in FIG. 8A. Again, the Event and Response fields are those introduced in the edge syntax above. As is shown in the graph 800, the second edge 830 is labeled as “<time out>→Output” as a depiction of the event that caused the transition and the output data that the example state machine 520 outputs in response to the transition. As mentioned, <time out> represents the expiration of a TTL timer for a node. In some cases, Output denotes void output data (which can be represented by “<void>”).

A first particular edge of the third edges 820 in the graph 800 represents a self-transition from the second node 620 to itself. That first particular edge is defined, at least partially, in terms of an Event corresponding to a Keyphrase and a Response representing defined output data. As mentioned, the Event and Response fields are those introduced in the edge syntax above. As is shown in the graph 800, the first particular edge is labeled as “Keyphrase→Output B” as a depiction of the event that caused the transition and the output data that the example state machine 520 outputs in response to the transition. In one example, the Keyphrase is a command or another type of instruction, such as “open the trunk,” “close the trunk,” “start engine,” or the like.

A second particular edge of the third edges 820 represents another self-transition from the second node 620 to itself. That second particular edge is defined, at least partially, in terms of an Event corresponding to the Wakeword and a Response representing a void datum (represented by <void>). Again, the Event and Response fields are those introduced in the edge syntax above. As is shown in the graph 800, the second particular edge is labeled as “Wakeword→<void>” as a depiction of the event that caused the transition and the absence of output data in response to the transition. In one example, the Keyphrase is a command or another type of instruction, such as “open the trunk,” “close the trunk,” “start engine,” or the like.

The statement that defines the second particular edge can include the ResetTimeout field set to “1” (see FIG. 8B, statement 854, as an example). Thus, in response to the second self-transition caused by a subsequent detection of the Wakeword, the TTL time for S1 can be reset, without providing any output data. The disclosure is not limited in that latter respect, and in some cases, output information can be provided in response to the second self-transition.

FIG. 8B is an example of a listing of statements that configures an example state machine 520 as represented by the graph 800 (FIG. 8A). The listing of statements includes the group of statements 710 and the statement 720 that are illustrated in FIG. 7A and have been described herein. The listing of statements shown in FIG. 8A also includes a second group of statements 850 defining respective edges in the graph 800. The second group of statements 850 include the first statement 734a, the second statement 734b, the third statement 734c, and the fourth statement 734d. The second group of statements 850 also include a statement 854 that defines an edge corresponding to a self-transition for S1 in response to detection of the same wakeup phrase (“hey analog” in FIG. 8B) that causes the transition from S0 to S1. The self-transition defined by the statement 854 does not cause the example state machine to provide output data (indicated by <void> in the statement 854).

One of the many efficiencies of controlling the operation of an apparatus using the keyphrase detection described herein is that several wakeup phrases can be configured and used by third parties irrespective of a specific wakeup phrase sanctioned by the control logic (e.g., control logic 530) implemented by the control module 160. In other words, while the control module 160 can be caused to energize the apparatus in response to the specific wakeup phrase, end-users can customize a wakeup phrase to energize the apparatus, without changes to the control logic accessed by the control module 160.

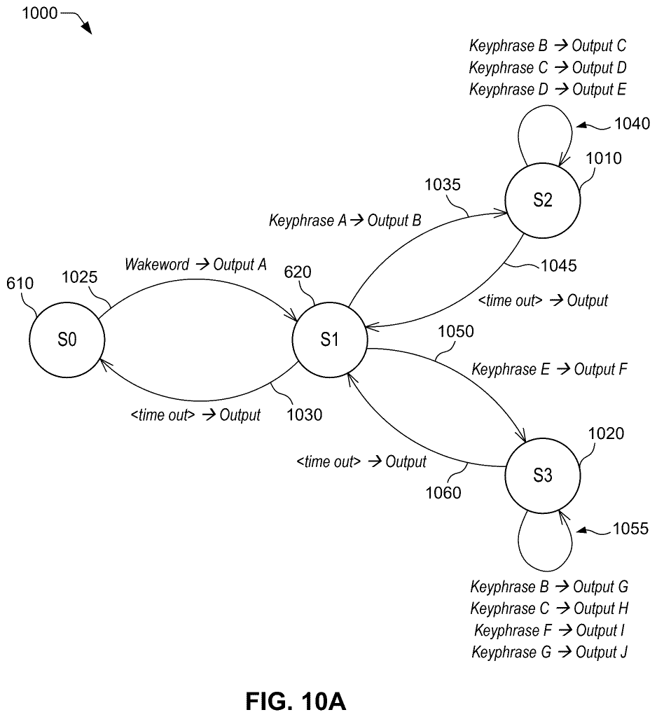

To use customized wakeup phrases to control the apparatus shown in FIG. 5, the state machine 520 can be configured to provide a specific wakeup phrase in response to detection of one of several customized wakeup phrases. Simply as an illustration, FIG. 9A is a graph 900 of an example state machine 520 that accepts multiple wakeup phrases and provides the specific wakeup phrase, in accordance with aspects described herein. The specific wakeup phrase can be compatible with control logic (e.g., the control logic 530) used by or otherwise accessible to the control module 160. For example, the specific wakeup phrase can be configured at factory during production of the apparatus shown in FIG. 5. The multiple wakeup phrases are represented by “Wakeword A,” “Wakeword B,” and “Wakeword C,” and the specific wakeup phrase is denoted by “Default Wakeword.” Although three wakeup phrases are depicted in FIG. 9A, fewer or more than three customized wakeup phrases can be configured.

The graph 900 has the first node 610 and the second node 620 corresponding, respectively, to the first state and the second state of the state machine 520. As described before, the first node 610 is labeled “S0,” simply for the sake of nomenclature, where the label S0 represents a unique natural number associated with that node. The second node 620 is labeled “S1,” again simply for the sake of nomenclature, where S1 represents a unique natural number associated with that node. Further, the graph 900 also has multiple edges, including multiple first edges 910, a second edge 920, and multiple third edges 930. Each one of the several first edges 910 represents a transition from the first node 610 to the second node 620.

A first particular edge of the first edges 910 is defined in terms of an Event corresponding to Wakeword A, and a Response representing output data indicative of the specific wakeup phrase (Default Wakeword). The Event and Response fields are those introduced in the edge syntax above. The first particular edge can be labeled as “Wakeword A→Default Wakeword” as a depiction of the event that caused the transition and the output data that the example state machine 520 outputs in response to the transition. In one example (see FIG. 9B), Wakeword A is the wakeup phrase “hey analog.”

A second particular edge of the first edges 910 is defined in terms of an Event corresponding to Wakeword B, and a Response representing output data indicative of the specific wakeup phrase (Default Wakeword). The Event and Response fields are those introduced in the edge syntax above. The second particular edge can be labeled as “Wakeword B→Default Wakeword” as a depiction of the event that caused the transition and the output data that the example state machine 520 outputs in response to the transition. In one example (see FIG. 9B), Wakeword B is the wakeup phrase “hi ADI.”

A third particular edge of the first edges 910 is defined in terms of an Event corresponding to Wakeword C, and a Response representing output data indicative of the specific wakeup phrase (Default Wakeword). The Event and Response fields are those introduced in the edge syntax above. The third particular edge is labeled as “Wakeword C→Default Wakeword” simply as a depiction of the event that caused the transition and the output data that the example state machine 520 outputs in response to the transition. In one example (see FIG. 9B), Wakeword C is the wakeup phrase “wake up analog.”

In view of the definition of the first edges 910, a transition from S0 to S1 causes the example state machine 520 to provide the specific wakeup phrase (e.g., “hey analog”) irrespective of the wakeup phrase that caused the transition.

The second edge 920 in the graph 900 represents a transition from the second node 620 to the first node 610. The second edge 920 is defined in terms of an Event corresponding to the expiration of a TTL timer for the node 620, and a Response representing output data (either defined information or a void datum). Again, the Event and Response fields are those introduced in the edge syntax above. The second edge 640 is labeled as “<time out>→Output” as a depiction of the event that caused the transition and the output data that the example state machine 520 outputs in response to the transition. As described before, <time out> represents the expiration of a TTL for a node. In some cases, Output denotes void output data (which can be represented by “<void>”).

A particular first edge of the third edges 930 represents a self-transition from the second node 620 to itself. The particular first edge is defined in terms of an Event corresponding to a Keyphrase A, and a Response representing defined output data. As mentioned, the Event and Response fields are those introduced in the edge syntax above. Such a particular first edge is labeled as “Keyphrase A→Output A” as a depiction of the event that caused the transition and the output data that the example state machine 520 outputs in response to the transition. In one example, the Keyphrase A is a command or another type of instruction, such as “open the trunk” (see FIG. 9B).

A particular second edge of the third edges 930 represents another self-transition from the second node 620 to itself. The particular second edge of third edges 930 is defined in terms of an Event corresponding to a Keyphrase B, and a Response representing defined output data. As mentioned, the Event and Response fields are those introduced in the edge syntax above. Such a particular second edge is labeled as “Keyphrase B→Output B” as a depiction of the event that caused the transition and the output data that the example state machine 520 outputs in response to the transition. In one example, the Keyphrase B is a command or another type of instruction, such as “close the trunk” (see FIG. 9B).

The graph 900, and the example state machine 520 represented by the graph 900, can be defined or otherwise configured by a listing of statements. Each statement in the list of statements defines an input event, a set of nodes in the graph, or an edge in the graph. The listing of statements can be retained a memory device of the apparatus 500.

FIG. 9B is a listing of statements that configures an example state machine 520 represented by the graph 900, in accordance with one or more aspects of this disclosure. The listing of statements includes a first group of statements 950 including keyphrases. Each one of the keyphrases defines an event that causes a state transition in the example state machine 520. Detection of a particular wakeup phrase in that group causes a particular state transition in the example state machine 520. The keyphrases include wakeup phrases and commands. Specifically, the keyphrases include a first wakeup phrase (“hey analog”), a second wakeup phrase (“hi ADI”), and a third wakeup phrase (“wake up analog”). The keyphrases also include a first command (“open the trunk”) and a second command (“close the trunk”).

The listing of statements also includes a statement 960 defining a first state and a second state. The first state and the second state are denoted, respectively, by “S0” and “S1,” where S0 represents a first unique identifier and S1 represents a second unique identifier. As is described herein, the first unique identifier and the second unique identifier identify respective nodes in the graph 900.

The listing of statements further includes a second group of statements 970 defining respective edges in such a graph. Specifically, first statements 972 in the second group of statements 970 define respective first edges, each corresponding to a transition from S0 to S1 in response to detection of a respective keyphrase. Each one of the first statements also defines that the transition from S0 to S1 causes the example state machine 520 to output a specific keyphrase (e.g., the wakeup phrase “hey analog”). Second statements 974 in the second group of statements 970 define respective second edges, each corresponding to a self-transition for S1 in response to detection of a respective second keyphrase. Each one of the second statements also defines that the self-transition causes the example state machine 520 to output the respective second keyphrase. A third statement 976 in the second group of statements 970 defines a third edge corresponding to a transition from S1 to S0 in response to a <time out>event—that is, expiration of a TTL timer for S1. The third statement also defines that the transition from S1 to S0 does not output any data, as is indicated by <void> in that statement.

The examples of the state machine 520 includes two states simply to illustrate the many concepts associated with control of an apparatus using a combination of keyphrase detection and a state machine. Indeed, as is described herein, the state machine 520 is not limited to having only two states. Thus, in some cases, a graph representing the state machine 520 in accordance with this disclosure can include more than two nodes in some cases.

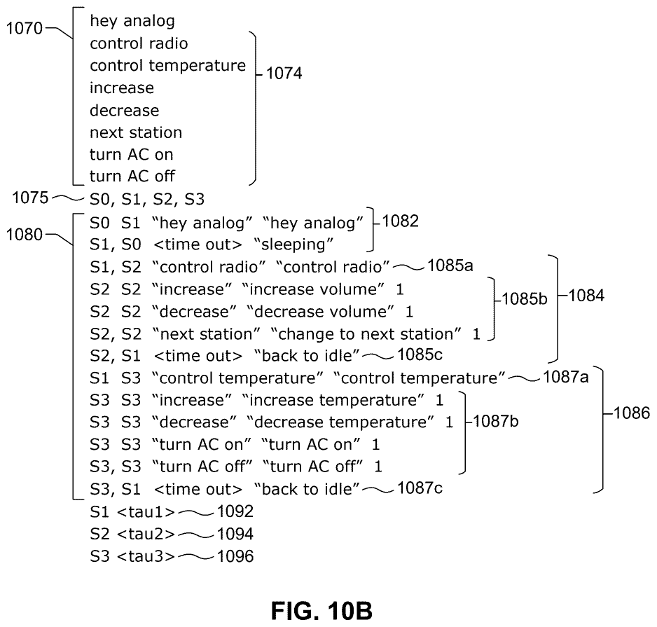

Simply as an illustration, FIG. 10A is a graph 1000 of an example state machine 520 that has more than two states. The graph 1000 has the first node 610 and the second node 620 corresponding, respectively, to the first state and the second state of the example state machine 520. As described hereinbefore, the first node 610 is labeled “S0,” simply for the sake of nomenclature, where the label S0 represents a unique natural number associated with that node. The second node 620 is labeled “S1,” again simply for the sake of nomenclature, where S1 represents a unique natural number associated with that node. Further the graph 1000 also has a third node 1010 and a fourth node 1020. The third node 1010 is labeled “S2,” simply for the sake of nomenclature, where the label S2 represents a unique natural number associated with that node. The fourth node 1020 is labeled “S3,” again simply for the sake of nomenclature, where S3 represents a unique natural number associated with that node. The disclosure is not limited to unique natural numbers as unique identifiers for the states of the example state machine 520. Other unique identifiers can be used.

The graph 1000 also has multiple edges, including a first edge 1025 that represents a transition from the first node 610 to the second node 620. The first edge 1025 is defined in terms of an Event corresponding to a wakeup phrase (denoted by Wakeword) and a Response representing defined output data (denoted by Output A). The Event and Response fields are those introduced in the edge syntax above. As is shown in the graph 1000, the first edge 1025 is labeled as “Wakeword→Output A” as a depiction of the event that caused the transition (e.g., detection of the wakeup phrase) and the output data that the example state machine 520 that is represented by the graph 1000 outputs in response to the transition. In one example, the wakeup phrase can be “hey analog” and the output data also can be “hey analog” (see FIG. 10B). In such an example, by applying of the example state machine 520, the operation module 510 causes at least a portion of the apparatus that includes the example state machine 520 to be energized. To that end, the operation module 510 can send the wakeup phrase “hey analog” to the control module 160. Then, by executing the control logic 530, with “hey analog” as an input, the control module 160 can cause one or more of the functionality component(s) 170. As a result, such an apparatus transitions to an idle state (represented by S1).

The multiple edges of the graph 1000 also include a second edge 1030 that represents a transition from the second node 620 to the first node 610. The second edge 1030 is defined in terms of an Event corresponding to the expiration of a TTL for the second node 620, and a Response representing output data (either defined information or a void datum). Again, the Event and Response fields are those introduced in the edge syntax above. As is shown in the graph 1000, the second edge 1030 is labeled as “<time out>→Output” as a depiction of the event that caused the transition and the output data that the example state machine 520 that is represented by the graph 1000 outputs in response to the transition. As is described herein, <time out> represents the expiration of a TTL for a node. In some cases, Output denotes void output data (which can be represented by “<void>”). In other cases, Output denotes timeout information. As is described herein, the timeout information is configurable. In one example, the timeout information can be the message “sleeping” (see FIG. 10B.)

The multiple edges of the graph 1000 also include a third edge 1035 that represents a transition from the second node 620 to the third node 1010. The third edge 1035 is defined in terms of an Event corresponding to a particular keyphrase (denoted by Keyphrase A) and a Response representing defined output data (denoted by Output B). The Event and Response fields are those introduced in the edge syntax above. As is shown in the graph 1000, the third edge 1035 is labeled as “Keyphrase A→Output B” as a depiction of the event that caused the transition (e.g., detection of the particular keyphrase) and the output data that the example state machine 520 that is represented by the graph 1000 outputs in response to the transition. In one example, the particular keyphrase (Keyphrase A) is a command or another type of instruction, such as “control radio,” and the defined output data (Output B) are indicative of “control radio” (see FIG. 10B). By supplying the defined output data indicative of “control radio,” the operation module 510 can cause the control module 160 to energize a specific subsystem included in the functionality component(s) 170 present in the apparatus that includes the example state machine 520 that is represented by the graph 1000. The specific subsystem can be a radio module. In response to causing the specific subsystem to be energized, the operation control module 160 can configure the apparatus in a particular operational context, where subsequent generic keywords that are detected can result in commands that are specific to the subsystem that has been energized.

The multiple edges of the graph 1000 further include first self-transition edges 1040, each representing a self-transition. A particular first edge of the first self-transition edges 1040 represents a self-transition from the third node 1010 to the third node 1010 itself. The particular first edge is defined in terms of an Event corresponding to a particular keyphrase (denoted by Keyphrase B) and a Response representing defined output data (denoted by Output C). As mentioned, the Event and Response fields are those introduced in the edge syntax above. Such a particular first edge is labeled as “Keyphrase B→Output C” as a depiction of the event that caused the transition (e.g., detection of the particular keyphrase) and the defined output data that the example state machine 520 that is represented by the graph 1000 outputs in response to the transition. In one example, the particular keyphrase (Keyphrase B) is a command or another type of instruction, such as “increase,” and the defined output data (Output C) define another command or instruction, such as “increase volume” (see FIG. 10B).

A particular second edge of the first self-transition edges 1040 represents another self-transition from the third node 1010 to the third node 1010 itself. The particular second edge is defined in terms of an Event corresponding to another particular keyphrase (denoted by Keyphrase C) and a Response representing other defined output data (denoted by Output D). As mentioned, the Event and Response fields are those introduced in the edge syntax above. Such a particular second edge is labeled as “Keyphrase C→Output D” as a depiction of the event that caused the transition (e.g., detection of such a particular keyphrase) and the output data that the example state machine 520 outputs in response to the transition. In one example, that other particular keyphrase (Keyphrase C) is a command or another type of instruction, such as “decrease,” and the defined output data (Output D) define another command or instruction, such as “decrease volume” (see FIG. 10B).

A particular third edge of the first self-transition edges 1040 represents yet another self-transition from the third node 1010 to the third node 1010 itself. The particular third edge is defined in terms of an Event corresponding to yet another particular keyphrase (denoted by Keyphrase D) and a Response representing yet other defined output data (denoted by Output E). As mentioned, the Event and Response fields are those introduced in the edge syntax above. Such a particular third edge is labeled as “Keyphrase D→Output E” as a depiction of the event that caused the transition (e.g., detection of such a particular keyphrase) and the defined output data that the example state machine 520 outputs in response to the transition. In one example, that other particular keyphrase (Keyphrase D) is indicative of a command, such as “next station” which is indicative of the command “change current station to the next station.” Additionally, the defined output data (Output E) define the command or another command, such as “next station” (see FIG. 10B).

In some situations, a TTL timer for the third node 1010 can elapse. In response, the example state machine 520 that is represented by the graph 1000 can transition out of the node 1010. Thus, as is illustrated in FIG. 10A, the multiple edges of the graph 1000 also include a fourth edge 1045 that represents a transition from the third node 1010 to the second node 620. The fourth edge 1045 is defined in terms of an Event corresponding to the expiration of a TTL for the third node 1010, and a Response representing defined output data (either defined information or a void datum). As mentioned, the Event and Response fields are those introduced in the edge syntax above. As is shown in the graph 1000, the fourth edge 1045 is labeled as “<time out>→Output” as a depiction of the event that caused the transition (e.g., expiration of a TTL) and the defined output data that the example state machine 520 that is represented by the graph 1000 outputs in response to the transition. As is described herein, <time out> represents the expiration of a TTL for a node. In some cases, Output denotes void output data (which can be represented by “<void>”). In other cases, Output denotes timeout information. As is described herein, the timeout information is configurable. In one example the timeout information includes the message “back to idle” (see FIG. 10B).

Further, the multiple edges of the graph 1000 also include a fifth edge 1050 that represents a transition from the second node 620 to the fourth node 1020. The fifth edge 1050 is defined in terms of an Event corresponding to a particular keyphrase (denoted by Keyphrase E) and a Response representing defined output data (denoted by Output F). The Event and Response fields are those introduced in the edge syntax above. As is shown in the graph 1000, the sixth edge 1050 is labeled as “Keyphrase E→Output F” as a depiction of the event that caused the transition (e.g., detection of the particular keyphrase) and the defined output data that the example state machine 520 that is represented by the graph 1000 outputs in response to the transition. In one example, the keyphrase (Keyphrase E) is a command or another type of instruction, such as “control temperature,” and the defined output data (Output F) include “control temperature” (see FIG. 10B). By supplying the defined output data indicative of “control temperature,” the operation module 510 can cause the control module 160 to energize a specific subsystem included in the functionality component(s) 170 present in the apparatus that includes the example state machine 520 that is represented by the graph 1000. The specific subsystem can be a heating ventilation and air conditioning (HVAC; automotive or otherwise) subsystem. As is described herein, in response to causing the specific subsystem to be energized, the operation control module 160 can configure the apparatus in a particular operational context, where subsequent generic keywords that are detected can result in commands that are specific to the subsystem that has been energized.

Furthermore, the multiple edges of the graph 1000 also include second self-transition edges 1055. A particular first edge of the second self-transition edges 1055 represents a self-transition from the fourth node 1020 to the fourth node 1020 itself. The particular first edge is defined in terms of an Event corresponding to a particular keyphrase (also denoted by Keyphrase B) and a Response representing defined output data (denoted by Output G). The particular keyphrase (Keyphrase B) can be the same as the particular keyphrase associated with the event that causes the self-transition corresponding to the particular first edge of the first self-transitions edges 1040. As mentioned, the Event and Response fields are those introduced in the edge syntax above. Such a particular first edge is labeled as “Keyphrase B→Output G” as a depiction of the event that caused the transition (e.g., detection of the particular keyphrase) and the defined output data that the example state machine 520 that is represented by the graph 1000 outputs in response to the transition. In one example, as is described herein, the particular keyphrase (Keyphrase B) is a command or another type of instruction, such as “increase,” and the defined output data (Output G) define another command or instruction, such as “increase temperature” (see FIG. 10B).

A particular second edge of the second self-transition edges 1055 represents another self-transition from the fourth node 1020 to the fourth node 1020 itself. The particular second edge is defined in terms of an Event corresponding to another particular keyphrase (denoted by Keyphrase C) and a Response representing defined output data (denoted by Output H). The particular keyphrase (Keyphrase C) can be the same as the particular keyphrase associated with the event that causes the self-transition corresponding to the particular second edge of the first self-transition edges 1040. As mentioned, the Event and Response fields are those introduced in the edge syntax above. Such a particular second edge is labeled as “Keyphrase C→Output H” as a depiction of the event that caused the transition (e.g., detection of that other particular keyphrase) and the defined output data that the example state machine 520 that is represented by the graph 1000 outputs in response to the transition. In one example, as is described herein, the particular keyphrase (Keyphrase C) is a command or another type of instruction, such as “decrease,” and the defined output data (Output H) define another command or instruction, such as “decrease temperature” (see FIG. 10B).

A particular third edge of the second self-transition edges 1055 represents yet another self-transition from the fourth node 1020 to itself. The particular third edge is defined in terms of an Event corresponding to yet another particular keyphrase (denoted by Keyphrase F) and a Response representing yet other defined output data (denoted by Output I). As mentioned, the Event and Response fields are those introduced in the edge syntax above. Such a particular third edge is labeled as “Keyphrase F→Output I” as a depiction of the event that caused the transition (e.g., detection of that other particular keyphrase) and the defined output data that the example state machine 520 that is represented by the graph 1000 outputs in response to the transition. In one example, that other particular keyphrase (Keyphrase F) is a command, such as “turn AC on,” and the defined output data (Output I) define the command or another command, such as “turn AC on” (see FIG. 10B).

A particular fourth edge of the second self-transition edges 1055 represents still another self-transition from the fourth node 1020 to itself. The particular fourth edge is defined in terms of an Event corresponding to still another particular keyphrase (denoted by Keyphrase G) and a Response representing still other defined output data (denoted by Output J). As mentioned, the Event and Response fields are those introduced in the edge syntax above. Such a particular fourth edge is labeled as “Keyphrase G→Output J” as a depiction of the event that caused the transition (e.g., detection of that other particular keyphrase) and the defined output data that the example state machine 520 that is represented by the graph 1000 outputs in response to the transition. In one example, that other particular keyphrase (Keyphrase G) is a command or another type of instruction, such as “turn AC off,” and the output data (Output K) define the command or another command, such as “turn AC off” (see FIG. 10B).

In some situations, a TTL timer for the fourth node 1020 can elapse. In response, the example state machine 520 that is represented by the graph 1000 can transition out of the fourth node 1020. Thus, as is illustrated in FIG. 10A, the multiple edges of the graph 1000 also include a sixth edge 1060 that represents a transition from the fourth node 1020 to the second node 620. The sixth edge 1060 is defined in terms of an Event corresponding to the expiration of a TTL for the fourth node 1020, and a Response representing output data (either defined information or a void datum). As mentioned, the Event and Response fields are those introduced in the edge syntax above. As is shown in the graph 1000, the sixth edge 1060 is labeled as “<time out>→Output” as a depiction of the event that caused the transition and the output data that the example state machine 520 that is represented by the graph 1000 outputs in response to the transition. Again, as is described herein, <time out> represents the expiration of a TTL for a node. In some cases, Output denotes void output data (which can be represented by “<void>”). In other cases, Output denotes timeout information. As is described herein, the timeout information is configurable. In one example the timeout information includes the message “back to idle” (see FIG. 10B). Also, the output data associated with the sixth edge 1060 need not be the same as the output data associated with the fifth edge 1045 and/or the second edge 1030.

The graph 1000, and the example state machine 520 represented by the graph 1000, can be defined or otherwise configured by a listing of statements. Each statement in the list of statements defines an input event, a set of nodes in the graph, or an edge in the graph. The listing of statements can be retained a memory device of the apparatus that implements the state machine 520, such as the apparatus 500.

FIG. 10B is a listing of statements that configures an example state machine 520 represented by the graph 1000, in accordance with one or more aspects of this disclosure. The listing of statements includes a first group of statements 1070 including keyphrases. Each one of the keyphrases defines an event—detection of keyphrase in speech—that causes a state transition in the example state machine 520. That is, detection of a particular keyphrase in the first group of statement 1070 causes a particular state transition in the example state machine 520. The particular state transition can be an inter-state transition or a self-transition. The keyphrases include a wakeup phrase (“hey analog”) and commands 1074. Specifically, the commands 1074 include “control radio,” “control temperature,” “increase,” “decrease,” “next station,” “turn AC on,” and “turn AC off.”

The listing of statements also includes a statement 1075 defining multiple states, including a first state, a second state, a third state, and fourth state. Those states are denotes, respectively, by “S0,” “S1,” “S2,” and “S3,” where S0 represents a first unique identifier, S1 represents a second unique identifier, S2 represents a third unique identifier, and S3 represents a third unique identifier. As is described herein, the first, second, third, and fourth unique identifiers identify respective nodes in the graph 1000, as is described herein.

The listing of statements further includes a second group of statements 1080 defining respective edges in the graph 1000. Specifically, the second group of statements 1080 includes first statements 1082 defining respective first edges, each corresponding to a respective transition between S0 to S1. One transition is an inter-state transition from S0 to S1 that is responsive to detection of the wakeup phrase defined in the group of statements 1070. Such a transition from S0 to S1 causes the example state machine 520 to output a specific keyphrase, e.g., the wakeup phrase “hey analog”. Another transition is an inter-state transition from S1 to S0 that is responsive to a <time out> event—that is, expiration of a TTL timer for S1. Such a transition from S1 to S0 causes the example state machine 520 to output timeout information, as represented by the word “sleeping” in the appropriate statement of the first statements 1082.

The second group of statements 1080 includes second statements 1084 defining respective second edges. More specifically, the second statements 1084 include a statement 1085a defining an edge corresponding to a transition from S1 to S2 that is responsive to detection of a specific keyphrase, e.g., “control radio.” Such a transition from S1 to S2 causes the example state machine 520 to output the specific keyphrase. The second statements 1084 also include a statement 1085c defining an edge corresponding to a transition from S2 to S1 responsive to a <time out> event—that is, expiration of a TTL timer for S2. Such a transition from S2 to S1 causes the example state machine 520 to output timeout information, as represented by “back to idle.” The second statements 1084 further include statements 1085b defining first self-transition edges, each corresponding to a respective self-transition for S2 in response to detection of a respective keyphrase. The respective self-transition causes the example state machine 520 to output a respective second keyphrase.

A particular self-transition edge of the first transition edges corresponds to a transition from S2 to S2 responsive to detection of a first command, e.g., “increase,” Such a self-transition causes the example state machine 520 to output a second command, e.g., “increase volume.” The first command is generic in that the first command exhorts some sort of increase without specifying the quantity that is to be increased or the amount by which the quantity is to be increased. The second command, however, is specific in that the second command specifies the increase of a particular quantity (e.g., volume). Thus, the second command that is output can permit the control module 160 (or, in some cases, another component) to control operation of a particular functionality element (e.g., a radio tuner) in response to an utterance conveying a generic command.

Another particular self-transition edge of the first transition edges corresponds to a transition from S2 to S2 responsive to detection of a third command, e.g., “decrease,” Such a self-transition causes the example state machine 520 to output a fourth command, e.g., “decrease volume.” Again, the third command is generic in that the third command exhorts some sort of decrease without specifying the quantity that is to be decreased or the amount by which the quantity is to be decreased. The fourth command, however, is specific in that the fourth command specifies the decrease of a particular quantity (e.g., volume). Thus, the fourth command that is output can permit the control module 160 (or, in some cases, another component) to control operation of a particular functionality element (e.g., a radio module) in response to an utterance conveying a generic command.

Yet another particular self-transition edge of the first transition edges corresponds to a transition from S2 to S2 responsive to detection of a particular keyphrase, e.g., “next station,” that is indicative of a particular command, such as “change current station to next station.” Such a self-transition causes the example state machine 520 to output the particular command or a variation of the particular command (e.g., “change to next station”).

The second group of statements 1080 further include third statements 1086 defining respective third edges involving one or a combination of S1 and S3. More specifically, the second statements 1086 include a statement 1087a defining an edge corresponding to a transition from S1 to S3 that is responsive to detection of a specific keyphrase, e.g., “control temperature.” Such a transition from S1 to S3 causes the example state machine 520 to output the specific keyphrase. The second statements 1086 also include a statement 1087c defining an edge corresponding to a transition from S3 to S1 responsive to a <time out> event—that is, expiration of a TTL timer for S3. Such a transition from S3 to S1 causes the example state machine 520 to output timeout information, as represented by the message “back to idle.” The third statements 1086 further include statements 1087b defining second self-transition edges, each corresponding to a respective self-transition for S3 in response to detection of a respective keyphrase. The respective self-transition causes the example state machine 520 to output a respective second keyphrase.

A particular self-transition edge of the second transition edges corresponds to a transition from S3 to S3 responsive to detection of a first command, e.g., “increase,” Such a self-transition causes the example state machine 520 to output a second command, e.g., “increase temperature.” The first command is generic in that the first command directs some sort of increase without specifying the quantity that is to be increased or the amount by which the quantity is to be increased. The second command, however, is specific in that the second command specifies the increase of a particular quantity (e.g., temperature). Thus, the second command that is output can permit the control module 160 (or, in some cases, another component) to control operation of a particular functionality element (e.g., heater or heating element) in response to an utterance conveying a generic command.

Another particular self-transition edge of the second transition edges corresponds to a transition from S3 to S3 responsive to detection of a third command, e.g., “decrease,” Such a self-transition causes the example state machine 520 to output a fourth command, e.g., “decrease temperature.” Again, the third command is generic in that the third command directs some sort of decrease without specifying the quantity that is to be decreased or the amount by which the quantity is to be decreased. The fourth command, however, is specific in that the fourth command specifies the decrease of a particular quantity (e.g., temperature). Thus, the fourth command that is output can permit the control module 160 (or, in some cases, another component) to control operation of a particular functionality element (e.g., heater or heating element) in response to an utterance conveying a generic command.

Yet another particular self-transition edge of the second transition edges corresponds to a transition from S3 to S3 responsive to detection of a particular command, e.g., “turn AC on,” Such a self-transition causes the example state machine 520 to output the particular command.

Still another particular self-transition edge of the second transition edges corresponds to a transition from S3 to S3 responsive to detection of another particular command, e.g., “turn AC off.” Such a self-transition causes the example state machine 520 to output that other particular command.

The listing of statements shown in FIG. 10B include additional statements associated with S1, S2, and S3, respectively. The additional statements include a first statement 1092 defining a first time interval that specifies the extent of a TTL of S1. In the first statement 1092, <tau1> denotes a particular amount of time expressed in a particular time unit. For example, <tau1> can be 2.5 s. The additional statements also include a second statement 1094 defining a second time interval that specifies the extent of a TTL of S2. In the second statement 1094, <tau2> denotes a particular amount of time expressed in a particular time unit. For example, <tau2> can be 3.5 s. The additional statements further include a third statement 1096 defining a third time interval that specifies the extent of a TTL of S3. In the third statement 1096, <tau3> denotes a particular amount of time expressed in a particular time unit. For example, <tau3> can be 3.5 s.

Although the various listings of statements that are illustrated and described herein include statements in a particular order, the disclosure is not limited in that respect. Indeed, the order of statements in a listing of statement defining a state machine can be changed without altering the state machine being defined or otherwise configured by the listing of statements.

The disclosure is not limited to the apparatus 450 (FIG. 4) or the apparatus 500 (FIG. 5) performing a task or a sequence of tasks in response to detecting a particular keyphrase or a sequence of particular keyphrases. The apparatus 450 and the apparatus 500 can, in some cases, cause equipment that is external to the apparatus 450 and the apparatus 500, respectively, to perform the task. To that end, the apparatus 450 and the apparatus 500 can optionally be functionally coupled to respective equipment (not depicted in FIG. 4 or FIG. 5) remotely located relative to the corresponding apparatus 450 or apparatus 500. For example, the apparatus 450 or the apparatus 500 can be a server device for home automation and the equipment functionally coupled therewith can include power locks distributed across doors and/or point of entry to a dwelling.

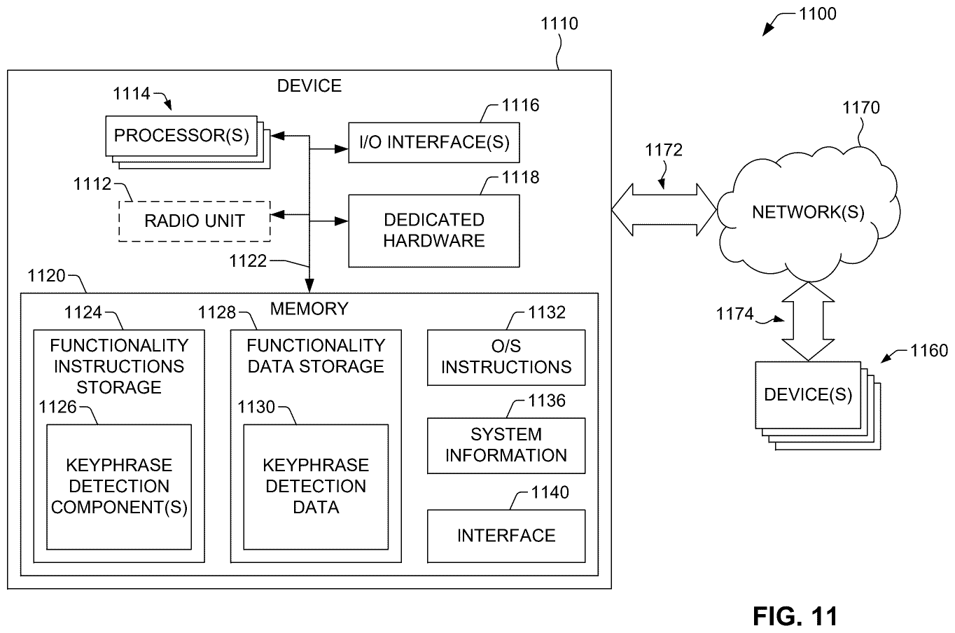

FIG. 11 is a block diagram of an example of a system of devices that can provide various functionalities of keyphrase detection and execution of control operation(s), in accordance with aspects of this disclosure. The example system 1100 includes a device 1110 and one or more remote devices 1160. The type of components for keyphrase detection that the device 1110 hosts can dictate the scope of keyphrase detection functionality that the device 1110 provides. In some cases, the device 1110 can host both the compilation module 110 and the detection module 130. Hence, the device 1110 can generate a keyphrase recognition model for multiple keyphrases, and also can apply the keyphrase recognition model to speech in order to detect one or more particular keyphrases of the multiple keyphrases. In such cases, the device 1110 also can host the control module 160 and can thus cause hardware (such as the dedicated hardware 1118) to perform a task in response to detection of a particular keyphrase. In other cases, the device 1110 can host either the compilation module 110 or the detection module 130. For example, the device 1110 can embody the computing device 410 or the apparatus 450. Accordingly, the device 1110 can either generate the keyphrase recognition model or can apply the keyphrase recognition model to speech to detect a particular keyphrase. In cases the device 1010 embodies the apparatus 450, the device 1110 also can host the control module 160. In cases the device 1110 embodies the apparatus 500, the device 1110 can host the control module 160 and the operation module 510.

The device 1110 can provide the various functionalities of keyphrase detection in response to execution of one or more software components retained within the device 1110. Such component(s) can render the device 1110 a particular machine for keyphrase detection, among other functional purposes that the device 1110 may have. A software component can be embodied in or can include one or more processor-accessible instructions, e.g., processor-readable instructions and/or processor-executable instructions. In one scenario, at least a portion of the processor-accessible instructions can embody and/or can be executed to perform at least a part of one or more of the example methods described herein. The one or more processor-accessible instructions that embody a software component can be arranged into one or more program modules, for example, that can be compiled, linked, and/or executed at the device 1110 or other computing devices. Generally, such program modules comprise computer code, routines, programs, objects, components, information structures (e.g., data structures and/or metadata structures), etc., that can perform particular tasks (e.g., one or more operations) in response to execution by one or more processors 1114 integrated into the device 1110.

The various example aspects of the disclosure can be operational with numerous other general purpose or special purpose computing system environments or configurations. Examples of well-known computing systems, environments, and/or configurations that can be suitable for implementation of various aspects of the disclosure in connection keyphrase detection can include personal computers; server computers; laptop devices; handheld computing devices, such as mobile tablets or electronic-book readers (e-readers); wearable computing devices; and multiprocessor systems. Additional examples can include programmable consumer electronics, network personal computers (PCs), minicomputers, mainframe computers, blade computers, programmable logic controllers, distributed computing environments that comprise any of the above systems or devices, and the like.

As is illustrated in FIG. 11, the device 1110 includes one or multiple processors 1114, one or multiple input/output (I/O) interfaces 1116, one or more memory devices 1120 (referred to as memory 1120), and a bus architecture 1122 (referred to as bus 1122) that functionally couples various functional elements of the device 1110. The device 1110 can include, optionally, a radio unit 1112. The radio unit 1112 can include one or more antennas and a communication processing device that can permit wireless communication between the device 1010 and another device, such as one of the remote device(s) 1160 and/or a remote sensor (not depicted in FIG. 11). The communication processing device can process data according to defined protocols of one or more radio technologies. The data that is processed can be received in a wireless signal or can be generated by the device 1110 for transmission in a wireless signal. The radio technologies can include, for example, 3G, Long Term Evolution (LTE), LTE-Advanced, 5G, IEEE 802.11, IEEE 802.16, Bluetooth, ZigBee, near-field communication (NFC), and the like.

The bus 1122 can include at least one of a system bus, a memory bus, an address bus, or a message bus, and can permit the exchange of information (data and/or signaling) between the processor(s) 1114, the I/O interface(s) 1116, and/or the memory 1120, or respective functional elements therein. In some cases, the bus 1122 in conjunction with one or more internal programming interfaces 1140 (also referred to as interface 1140) can permit such exchange of information. In cases where the processor(s) 1114 include multiple processors, the device 1110 can utilize parallel computing.

The I/O interface(s) 1116 can permit communication of information between the device 1110 and an external device, such as another computing device. Such communication can include direct communication or indirect communication, such as the exchange of information between the device 1110 and the external device via a network or elements thereof. As illustrated, the I/O interface(s) 1116 can include one or more of network adapter(s), peripheral adapter(s), and display unit(s). Such adapter(s) can permit or facilitate connectivity between the external device and one or more of the processor(s) 1114 or the memory 1120. For example, the peripheral adapter(s) can include a group of ports, which can include at least one of parallel ports, serial ports, Ethernet ports, V.35 ports, or X.21 ports. In certain aspects, the parallel ports can comprise General Purpose Interface Bus (GPIB), IEEE-1284, while the serial ports can include Recommended Standard (RS)-232, V.11, Universal Serial Bus (USB), FireWire or IEEE-1394. In some cases, at least one of the I/O interface(s) can embody or can include the audio input unit 150 (FIG. 1 and FIG. 5).

The I/O interface(s) 1116 can include a network adapter that can functionally couple the device 1110 to one or more remote devices 1160 or sensors (not depicted in FIG. 11) via a communication architecture. The communication architecture includes communication links 1172, one or more networks 1170, and communication links 1174 that can permit or otherwise facilitate the exchange of information (e.g., traffic and/or signaling) between the device 1110 and the one or more remote devices 1160 or sensors. The communication links 1172 can include upstream links (or uplinks (ULs)) and/or downstream links (or downlinks (DLs)). The communication links 1174 also can include ULs and/or DLs. Each UL and DL included in the communication links 1172 and communication links 1174 can be embodied in or can include wireless links, wireline links (e.g., optic-fiber lines, coaxial cables, and/or twisted-pair lines), or a combination thereof. The network(s) 1170 can include several types of network elements, including access points; router devices; switch devices; server devices; aggregator devices; bus architectures; a combination of the foregoing; or the like. The network elements can be assembled to form a local area network (LAN), a wide area network (WAN), and/or other networks (wireless or wired) having different footprints. One or more links in communication links 1174, one or more links of the communication links 1172, and at least one of the network(s) 1170 form a communication pathway between the device 1110 and at least one of the remote device(s) 1160.

Such network coupling that is provided at least in part by the network adapter can thus be implemented in a wired environment, a wireless environment, or both. The information that is communicated by the network adapter can result from the implementation of one or more operations of a method in accordance with aspects of this disclosure. The I/O interface(s) 1116 can include more than one network adapter in some cases. In an example configuration, a wireline adapter is included in the I/O interface(s) 1116. Such a wireline adapter includes a network adapter that can process data and signal according to a communication protocol for wireline communication. Such a communication protocol can be one of TCP/IP, Ethernet, Ethernet/IP, Modbus, or Modbus TCP, for example. The wireline adapter also includes a peripheral adapter that permits functionally coupling the apparatus to another apparatus or an external device. The combination of such a wireline adapter and the radio unit 1112 can form a communication unit that permits both wireline and wireless communications.

In addition, or in some cases, depending on the architectural complexity and/or form factor the device 1110, the I/O interface(s) 1116 can include a user-device interface unit that can permit control of the operation of the device 1110, or can permit conveying or revealing the operational conditions of the device 1110. The user-device interface can be embodied in, or can include, a display unit. The display unit can include a display device that, in some cases, has touch-screen functionality. In addition, or in some cases, the display unit can include lights, such as light-emitting diodes, that can convey an operational state of the device 1110.

The bus 1122 can have at least one of several types of bus structures, depending on the architectural complexity and/or form factor the device 1110. The bus structures can include a memory bus or a memory controller, a peripheral bus, an accelerated graphics port, and a processor or local bus using any of a variety of bus architectures. As an illustration, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, a Peripheral Component Interconnect (PCI) bus, a PCI-Express bus, a Personal Computer Memory Card International Association (PCMCIA) bus, a Universal Serial Bus (USB), and the like.

The device 1110 can include a variety of processor-readable media. Such a processor-readable media (e.g., computer-readable media or machine-readable media) can be any available media (transitory and non-transitory) that can be accessed by a processor or a computing device (or another type of apparatus) having the processor, or both. In one aspect, processor-readable media can comprise computer non-transitory storage media (or computer-readable non-transitory storage media) and communications media. Examples of processor-readable non-transitory storage media include any available media that can be accessed by the device 1110, including both volatile media and non-volatile media, and removable and/or non-removable media. The memory 1120 can include processor-readable media (e.g., computer-readable media or machine-readable media) in the form of volatile memory, such as random access memory (RAM), and/or non-volatile memory, such as read-only memory (ROM).

The memory 1120 can include functionality instructions storage 1124 and functionality data storage 1128. The functionality instructions storage 1124 can include computer-accessible instructions that, in response to execution (by at least one of the processor(s) 1114, for example), can implement one or more of the functionalities of this disclosure in connection with keyphrase detection. The computer-accessible instructions can embody, or can include, one or more software components illustrated as keyphrase detection component(s) 1126. Execution of at least one component of the keyphrase detection component(s) 1126 can implement one or more of the methods described herein. Such execution can cause a processor (e.g., one of the processor(s) 1114) that executes the at least one component to carry out at least a portion of the methods disclosed herein. In some cases, the keyphrase detection component(s) 1126 can include the compilation module 110, the detection module 130, the operation module 510, and the control module 160. In other cases, the keyphrase detection component(s) 1126 can include the compilation module 110 or a combination of the detection module 130, the operation module 510, and the control module 160. In some configurations, the device 1110 can include a controller device that is part of the dedicated hardware 1118. The dedicated hardware 1118 can be specific to the functionality of the device 1110, and can include the functionality component(s) 170 and/or other types of functionality components described herein. Such a controller device can embody, or can include, the controller module 160 in some cases.

A processor of the processor(s) 1114 that executes at least one of the keyphrase detection component(s) 1126 can retrieve data from or retain data in one or more memory elements 1130 in the functionality data storage 1128 in order to operate in accordance with the functionality programmed or otherwise configured by the keyphrase detection component(s) 1126. The one or more memory elements 1130 may be referred to as keyphrase detection data 1130. Such information can include at least one of code instructions, data structures, or similar. For instance, at least a portion of such data structures can be indicative of a keyphrase recognition model (e.g., keyphrase recognition model 114, a state machine (e.g., state machine 520), documents defining keyphrases, documents defining state machines, state data, data relevant to keyphrase detection, and/or data relevant to control of a device, in accordance with aspects of this disclosure.

The interface 1140 (e.g., an application programming interface) can permit or facilitate communication of data between two or more components within the functionality instructions storage 1124. The data that can be communicated by the interface 1140 can result from implementation of one or more operations in a method of the disclosure. In some cases, one or more of the functionality instructions storage 1124 or the functionality data storage 1128 can be embodied in or can comprise removable/non-removable, and/or volatile/non-volatile computer storage media.

At least a portion of at least one of the keyphrase detection component(s) 1126 or the keyphrase detection data 1130 can program or otherwise configure one or more of the processors 1114 to operate at least in accordance with the functionality described herein. One or more of the processor(s) 1114 can execute at least one of the keyphrase detection component(s) 1126, and also can use at least a portion of the data in the functionality data storage 1128 in order to provide keyphrase detection and control in accordance with aspects described herein. In some cases, the functionality instructions storage 1124 can embody or can comprise a computer-readable non-transitory storage medium having computer-accessible instructions that, in response to execution, cause at least one processor (e.g., one or more of the processor(s) 1114) to perform a group of operations comprising the operations or blocks described in connection with example methods disclosed herein.

In addition, the memory 1120 can include processor-accessible instructions and information (e.g., data, metadata, and/or program code) that permit or facilitate the operation and/or administration (e.g., upgrades, software installation, any other configuration, or the like) of the device 1110. Accordingly, in some cases, as illustrated in FIG. 11, the memory 1120 can include a memory element 1132 (labeled operating system (O/S) instructions 1132) that contains one or more program modules that embody or include one or more operating systems, such as Windows operating system, Unix, Linux, Symbian, Android, Chromium, and substantially any OS suitable for mobile computing devices or tethered computing devices. In one aspect, the operational and/or architectural complexity of the device 1110 can dictate a suitable O/S. The memory 1120 also includes system information storage 1136 having data, metadata, and/or program code that permits or facilitates the operation and/or administration of the device 1110. Elements of the O/S instructions 1132 and the system information storage 1136 can be accessible or can be operated on by at least one of the processor(s) 1114.

While the functionality instructions retained in the functionality instructions storage 1124 and other executable program components, such as the O/S instructions 1132, are illustrated herein as discrete blocks, such software components can reside at various times in different memory components of the device 1110, and can be executed by at least one of the processor(s) 1114.

The device 1110 can include a power supply (not shown), which can power up components or functional elements within such devices. The power supply can be a rechargeable power supply, e.g., a rechargeable battery, and it can include one or more transformers to achieve a power level suitable for the operation of the device 1110 and components, functional elements, and related circuitry therein. In some cases, the power supply can be attached to a conventional power grid to recharge and ensure that such devices can be operational. To that end, the power supply can include an I/O interface (e.g., one of the interface(s) 1116) to connect to the conventional power grid. In addition, or in other cases, the power supply can include an energy conversion component, such as a solar panel, to provide additional or alternative power resources or autonomy for the device 1110.

In some scenarios, the device 1110 can operate in a networked environment by utilizing connections to one or more remote devices 1160 and/or sensors (not depicted in FIG. 11). As an illustration, a remote device can be a personal computer, a portable computer, a server, a router, a network computer, a peer device or other common network node, and so on. As mentioned, the device 1110 can embody or can include a first apparatus in accordance with aspects described herein. Thus, simply as an illustration, the peer device can be a second apparatus also in accordance with aspects of this disclosure. The second apparatus can have same or similar functionality as the first apparatus—e.g., first apparatus and the second apparatus can both be welding robots or painting robots in an assembly line. In addition, or in some cases, besides including a peer device that is an apparatus, another remote device of the remote devices 1160 can include the computing device 410 (FIG. 4). As described herein, connections (physical and/or logical) between the device 1110 and a remote device or sensor can be made via communication links 1172, one or more networks 1170, and communication links 1174, which can comprise wired link(s) and/or wireless link(s) and several network elements (such as routers or switches, concentrators, servers, and the like) that form a LAN, a WAN, and/or other networks (wireless or wired) having different footprints.

One or more of the techniques disclosed herein can be practiced in distributed computing environments, such as grid-based environments, where tasks can be performed by remote processing devices (e.g., network servers) that are functionally coupled (e.g., communicatively linked or otherwise coupled) through a network having traffic and signaling pipes and related network elements. In a distributed computing environment, one or more software components (such as program modules) may be located in both the device 1010 and at least one remote computing device.

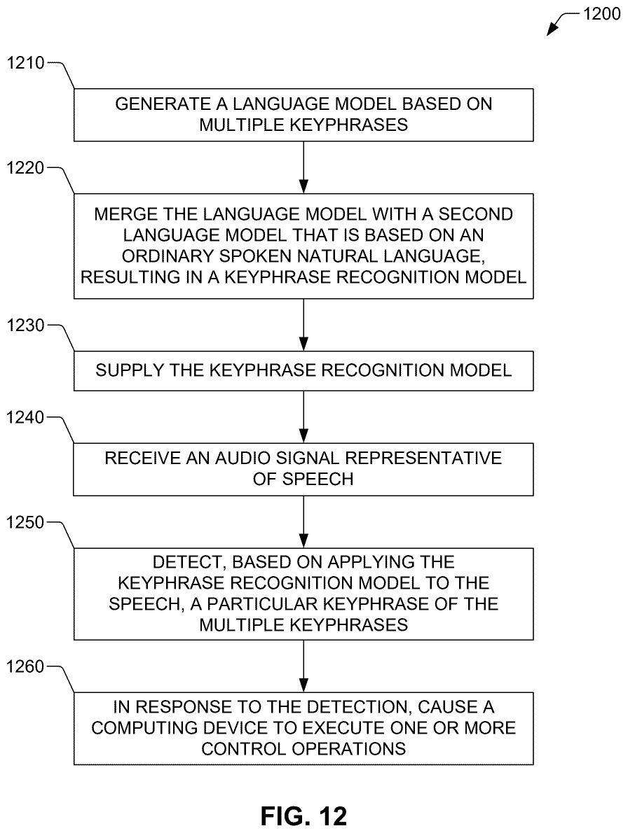

Example methods that can be implemented in accordance with this disclosure can be better appreciated with reference to FIGS. 12-15. For purposes of simplicity of explanation, example methods disclosed herein are presented and described as a series of acts. The example methods are not limited by the order of the acts, as some acts may occur in different orders and/or concurrently with other acts from that shown and described herein. In some cases, one or more example methods disclosed herein can alternatively be represented as a series of interrelated states or events, such as in a state diagram depicting a state machine. In addition, or in other cases, interaction diagram(s) (or process flow(s)) may represent methods in accordance with aspects of this disclosure when different entities enact different portions of the methodologies. It is noted that not all illustrated acts may be required to implement a described example method in accordance with this disclosure. It is also noted that two or more of the disclosed example methods can be implemented in combination with each other, to accomplish one or more functionalities described herein.

Methods disclosed herein can be stored on an article of manufacture in order to permit or otherwise facilitate transporting and transferring such methodologies to computers or other types of information processing apparatuses for execution, and thus implementation, by one or more processors, individually or in combination, or for storage in a memory device or another type of computer-readable storage device. In one example, one or more processors that enact a method or combination of methods described herein can be utilized to execute program code retained in a memory device, or any processor-readable or machine-readable storage device or non-transitory media, in order to implement method(s) described herein. The program code, when configured in processor-executable form and executed by the one or more processors, causes the implementation or performance of the various acts in the method(s) described herein. The program code thus provides a processor-executable or machine-executable framework to enact the method(s) described herein. Accordingly, in some cases, each block of the flowchart illustrations and/or combinations of blocks in the flowchart illustrations can be implemented in response to execution of the program code.

FIG. 12 illustrates an example of a method for detecting keyphrases, in accordance with one or more aspects of this disclosure. The example method 1200 illustrated in FIG. 12 can be implemented by a single computing device or a system of computing devices. To that end, each computing device includes various types of computing resources, such as a combination of one or multiple processors, one or multiple memory devices, one or multiple network interfaces (wireless or otherwise), or similar resources. Additionally, in some cases, a computing device involved in the implementation of the method 1200 can include functional elements that can provide particular functionality. Those functional elements can include, for example, a loudspeaker, a microphone, a camera device, a motorized brushing assembly, a robotic arm, a fan, a fluid pump, a vacuum pump, a motor, a heating element, power locks, or similar.

In some cases, a system of computing devices implements the example method 1200. The system of computing devices can include the compilation module 110 and the detection module 130, among other modules and/or components. The system of computing devices also can include the audio input unit 150.

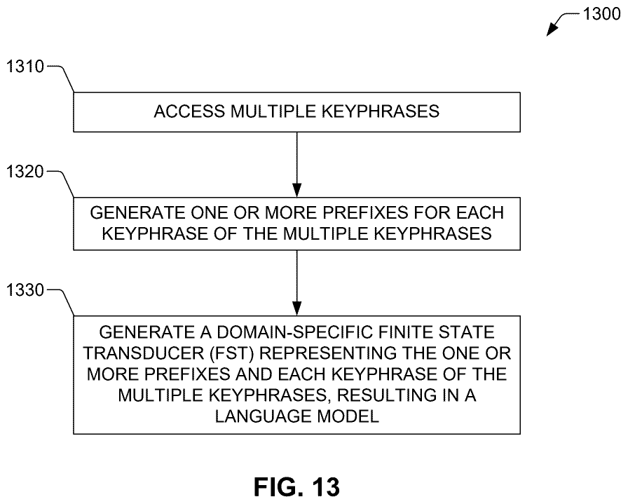

At block 1210, the system of computing devices (via the compilation module 110, for example) can generate a language model based on multiple keyphrases. The language model is a domain-specific language model and, as is described herein, can be a statistical n-gram model. The multiple keyphrases define a domain. The language model can be generated by implementing the example method illustrated in FIG. 13.

At block 1220, the system of computing devices (via the compilation module 110, for example) can merge the language model with a second language model that is based on an ordinary spoken natural language. The second language model can correspond to a wide-vocabulary FST representing the ordinary spoken natural language. Examples of the natural language include English, German, Spanish, or Portuguese. Merging such models results a keyphrase recognition model. Merging the language model with the second language model can include configuring first probabilities to sequences of words corresponding to respective keyphrases, and assigning second probabilities to sequences of words from ordinary speech where the second probabilities are similar to the wide-vocabulary FST for ordinary spoken natural language. The first probabilities can be higher than the second probabilities. Thus, the merged FST can assign a probability to a word as a product of one of the second probabilities for that word and one of the first probabilities for the keyphrase containing that word.

At block 1230, the system of computing devices can supply the keyphrase recognition model. To that end, in some cases, a first computing device of the system of computing devices can send the keyphrase recognition model to a second computing device of the system of computing devices. In one example, the first computing device is or includes the computing device 410 (FIG. 4) and the second computing device is or includes the apparatus 450 (FIG. 4). In another example, the first computing device is or includes the computing device 410 (FIG. 4) and the second computing device is or includes the apparatus 500 (FIG. 5).

At block 1240, the system of computing devices can receive an audio signal representative of speech. The audio signal can be received by means of the audio input unit 150, for example. The audio signal can be external to one of the computing devices within the system, and in some cases, can be representative of both the speech and ambient audio.

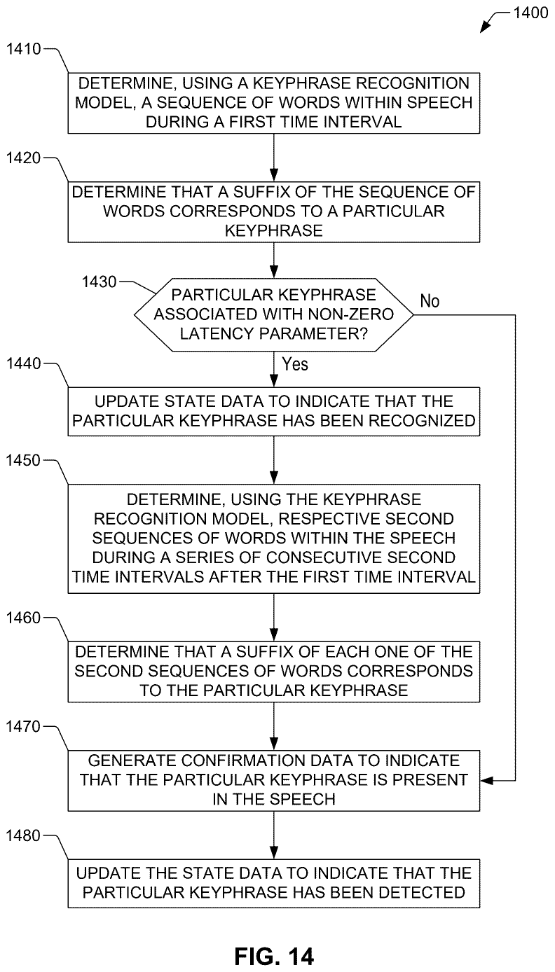

At block 1250, the system of computing devices (via the detection module 130, for example) can detect, based on applying the keyphrase recognition model to the speech, a particular keyphrase of the multiple keyphrases. An approach to detecting the particular keyphrase in such a fashion is illustrated in the example method illustrated in FIG. 14. Accordingly, the system of computing devices can implement the example method 1400 (FIG. 14) to detect, based on applying the keyphrase recognition model to the speech, a particular keyphrase of the multiple keyphrases.

At block 1260, in response to detecting the particular keyphrase, the system of computing devices (via the detection module 130 or the control module 160, for example) can cause at least one functional component of a computing device (or another type of apparatus) to execute one or more control operations. The computing device can be a part of the system of computing devices.

FIG. 13 illustrates an example of a method for generating a keyphrase recognition model, in accordance with one or more aspects of this disclosure. The example method 1300 illustrated in FIG. 13 can be implemented by a single computing device or a system of computing devices. To that end, as is described herein, each computing device includes various types of computing resources, such as a combination of one or multiple processors, one or multiple memory devices, one or multiple network interfaces (wireless or otherwise), or similar resources.

In some cases, a computing device implements the example method 1300. The computing device can include the compilation module 110, among other modules and/or components. As such, the computing device can implement the example method 1300 by means of the compilation module 110. The computing device can be part of the system of computing devices that can implement the example method 1200 (FIG. 12), in some cases.

At block 1310, the computing device can access multiple keyphrases—e.g., a combination of two or more of “hello analog,” “open the windows,” “Asterix stop,” “lock the patio door,” “change gas flow,” “increase temperature,” “shut down,” “turn on the lights,” or “lower the volume.” Accessing the multiple keyphrases can include reading a document retained within a filesystem of the computing device. The document can be a text file that defines the multiple keyphrases. An example of the document is the document 122 (FIG. 1).

At block 1320, the computing device can generate one or more prefixes for each keyphrase of the multiple keyphrases. For example, in case the multiple keyphrases include “open the window” and “Asterix stop,” the computing device can generate the following prefixes: “open the” and “open,” and “Asterix.”

At block 1330, the computing device can generate a domain-specific FST representing the one or more prefixes and each keyphrase of the multiple keyphrases. Generating the domain-specific FST results in a language model corresponding to the multiple keyphrases.

FIG. 14 illustrates an example of a method for detecting a keyphrase, in accordance with one or more aspects of this disclosure. The example method 1400 illustrated in FIG. 14 can be implemented by a single computing device or a system of computing devices. To that end, as is described herein, each computing device includes various types of computing resources, such as a combination of one or multiple processors, one or multiple memory devices, one or multiple network interfaces (wireless or otherwise), or similar resources. Additionally, in some cases, a computing device involved in the implementation of the method 1400 can include functional elements that can provide particular functionality. Those functional elements can include, for example, a loudspeaker, a microphone, a camera device, a motorized brushing assembly, a robotic arm, a fan, a fluid pump, a vacuum pump, a motor, a heating element, power locks, or similar. The functional elements can embody or can be part of the functionality component(s) 170.

In some cases, a computing device implements the example method 1400. The computing device can include the detection module 130 (FIG. 2, for example) among other modules and/or components. As such, the computing device can implement the example method 1400 by means of the detection module 130 (FIG. 2, for example). The computing device can be part of the system of computing devices that can implement the example method 1200 (FIG. 12), in some cases.

At block 1410, the computing device can determine, using a keyphrase recognition model, a sequence of words within speech during a first time interval. The sequence of words can be determined by means of an ASR component, for example. The ASR component (e.g., ASR component 230 (FIG. 2)) can be integrated into the detection module 130, for example. The first time interval can span a defined time period (e.g., 128 ms). As is described herein, the defined time period can be referred to as a tick, simply for the sake of nomenclature.

At block 1420, the computing device can determine that a suffix of the sequence of words corresponds to the particular keyphrase. Determining such a suffix indicates that the particular keyword has been recognized. For example, the keyphrase can be “lock the patio door” and, thus, the suffix is “lock the patio door.”

At block 1430, the computing device can determine if the particular keyphrase is associated with a non-zero latency parameter. As is described herein, the non-zero latency parameter can define an intervening time period between an initial recognition of the keyphrase and confirmation recognition of the keyphrase. The confirmation recognition is a subsequent recognition that occurs immediately after the intervening time period has elapsed. The non-zero latency parameter can define the intervening time period as a multiple of a tick. Thus, a non-zero latency parameter causes the computing device to wait a number of ticks before recognizing the particular keyphrase at a time interval corresponding to an immediately consecutive tick, and thus arriving at the confirmation recognition.

In response to a positive determination at block 1430, the computing device can take the “Yes” branch. Thus, the flow of the example method 1400 proceeds to block 1440, where the computing device can update state data to indicate that the particular keyphrase has been recognized in the speech during the first time interval. The state data can define a state variable for the particular keyphrase, and updating the state data can include updating the state variable to a first value indicating that the particular keyphrase has been recognized in the speech during the first time interval.

At block 1450, the computing device can determine, using the keyphrase recognition model, respective second sequences of words within the speech during time intervals of a series of consecutive second time intervals (e.g., consecutive ticks) after the first time interval. The respective second sequences of words also can be determined by means of the ASR component (e.g., ASR component 230 (FIG. 2)) relied upon to determine the sequence of words at block 1410. Each one of the second time intervals in the series also can span the defined time period (e.g., 128 ms). The series of consecutive second time intervals can begin immediately after the first time interval elapsed and spans an intervening time period. In some cases, the series can have a single second time interval beginning immediately after the first time interval elapses. The intervening time period can correspond to a multiple of the defined time period (e.g., N_{L}≥1). In other words, the series of consecutive second time intervals can be a series of consecutive ticks subsequent to the first tick associated with the initial recognition of the particular keyphrase at the first time interval. A terminal tick in the series is delayed relative to the first tick by the intervening time period. As mentioned, the intervening time period can be referred to as a confirmation period.

At block 1460, the computing device can determine that a suffix of each one of the respective second sequences of words corresponds to the particular keyphrase. In other words, the computing device can determine one or more subsequent recognitions of the particular keyphrase during the confirmation period, until the confirmation period elapses. Accordingly, at block 1470, the computing device can generate confirmation data indicative of the particular keyphrase being present in the speech in a terminal time interval of the series of consecutive second time intervals.

At block 1480, the computing device can update the state data to indicate that the particular keyphrase has been detected in the terminal time interval. As is described herein, the state data can define a state variable for the particular keyphrase, and updating the state data can include updating the state variable to a first value indicating that the particular keyphrase has been detected in the second sequence of words associated with the second time interval.

In response to a negative determination at block 1430, the computing device can take the “No” branch. Accordingly, the flow of the example method 1400 proceeds to block 1470 and then to block 1480.

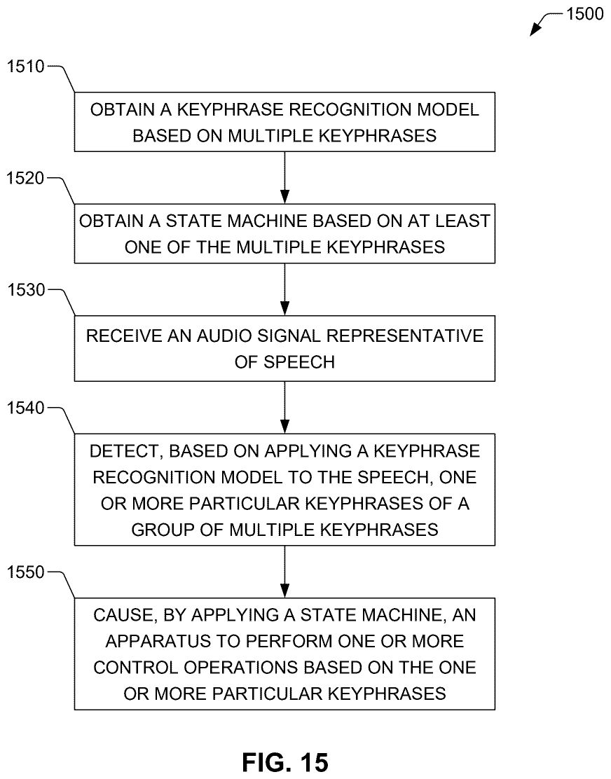

FIG. 15 illustrates an example of a method for controlling operation of an apparatus using speech, in accordance with one or more aspects of this disclosure. Control of the operation of the apparatus is based on keyphrase detection combined with application of a state machine, as is described herein. The example method 1500 illustrated in FIG. 15 can be implemented by the apparatus. To that end, as is described herein, the apparatus includes various types of computing resources, such as a combination of one or multiple processors, one or multiple memory devices, one or multiple network interfaces (wireless or otherwise), or similar resources. As such, the apparatus also can be referred to as a computing device. In some cases, the apparatus that implements the example method 1500 includes the detection module 130, the operation module 510, and the control module 160 (including the control logic 530), among other modules and/or components. The apparatus also includes the audio input unit 150. The apparatus can be, for example, the apparatus 500 (FIG. 5) or another apparatus in accordance with aspects of this disclosure.

The apparatus that implements the method 1500 includes functional elements that can provide particular functionality. Those functional elements can include, for example, a loudspeaker, a microphone, a camera device, a motorized brushing assembly, a robotic arm, a fan, a fluid pump, a vacuum pump, a motor, a heating element, power locks, or similar. The functional elements can embody or can be part of the functionality component(s) 170.

At block 1510, the apparatus can obtain a keyphrase recognition model. To that end, the apparatus can receive the keyphrase recognition model from a computing device (e.g., computing device 410) that is external to the apparatus. In an example scenario, the apparatus can receive the keyphrase recognition model at factory during production of the apparatus. In another example scenario, the apparatus can receive the keyphrase recognition model in the field, as part of a configuration stage (an initialization stage or an update stage, for example). Regardless of how the keyphrase recognition model is obtained, the keyphrase recognition model can be configured (e.g., generated) as is described herein, and thus, the keyphrase recognition model is based on multiple keyphrases. In one example, the keyphrase recognition model is the keyphrase recognition model 114 (FIG. 1).

At block 1520, the apparatus can obtain a state machine based on at least one of the multiple keyphrases. For instance, the state machine can be based on a subset of two or more of the multiple keyphrases. The state machine is configured according to aspects described herein. As such, the state machine can be defined or otherwise configured, at least partially, by a listing of statements defining a graph that represents the state machine. An example of the state machine is the state machine 520 (or an example thereof) described herein.

Obtaining the state machine includes receiving such a listing of statements. In some cases, the listing of statements can be received individually, from a computing device that is external to the apparatus. In this fashion, an existing state machine within the apparatus can be updated incrementally, resulting in the state machine. In other cases, the listing of statement can be received collectively, from the computing device. As such, receiving the listing of statements includes receiving one or more of (A) a first statement defining an input event that causes a state transition in the state machine, where the event comprises detection of a keyphrase; (B) a second statement defining multiple nodes in the graph; (C) or a third statement defining an edge in the graph. The third statement can obey the edge syntax described hereinbefore. Thus, the third statement comprises multiple fields including a first field corresponding to a first unique identifier indicative of an originating node for the edge, a second field corresponding to a second unique identifier indicative of a terminating node for the edge, a third field indicative of the input event, and a fourth field defining output data in response to the state transition. The computing device that supplies the listing of statements can be the same computing device that supplies the keyphrase recognition model.

At block 1530, the apparatus can receive an audio signal representative of speech. In some cases, the apparatus includes the audio input 150, and the audio signal can be received by means of that audio input unit 150. The audio signal can be external to the apparatus. In some cases, the audio signal can be representative of both the speech and ambient audio.

At block 1540, the apparatus can detect, based on applying the keyphrase recognition model to the speech, one or more particular keyphrases of multiple keyphrases. To that end, the apparatus can implement the example method shown in FIG. 14 and described herein.

At block 1550, the apparatus can cause, by applying the state machine, the performance of one or more control operations based on the one or more particular keyphrases. Causing the performance of the control operation(s) includes determining that a first particular keyphrase of the one or more particular keyphrases corresponds to a first input event of the state machine obtained at block 1520. The first input event causes the state machine to transition from a first state to a second state. Causing the performance of the control operation(s) also includes supplying output data in response to the transition from the first state to the second state. The output data can be supplied to a control module, or another type of module, that is present in the apparatus. In some cases, the output data can be indicative of the first particular keyphrase or another particular keyphrase. The output data—e.g., the first particular keyphrase or the other particular keyphrase—cause the apparatus to perform, via one or more functional elements, a first control operation of the one or more control operations. As mentioned, the one or more functional elements can include the functionality component(s) 170.

In some cases, causing the performance of the control operation(s) also includes determining that a second particular keyphrase of the one or more particular keyphrases corresponds to a second input event of the state machine. The second input event causes, in some cases, the state machine to transition from a second state to the second state. In other words, the second input event causes a self-transition, as is described herein. Causing the performance of the control operation(s) can further include supplying second output data in response to the self-transition. The second output data can be supplied to the control module, or the other type of module, that is present in the apparatus. In some cases, the output data can be indicative of the second particular keyphrase or yet another particular keyphrase. The second output data—e.g., the second particular keyphrase or that other particular keyphrase-cause the apparatus to perform, via the one or more functional elements, a second control operation of the one or more control operations.

As is described herein, a node representing a state of the state machine can have a TTL. Accordingly, in some cases, causing the performance of the control operation(s) can further include determining that a time interval corresponding to a TTL of the node representing the second state has elapsed, and then causing the state machine to transition from the second state to the first state. Causing the performance of the control operation(s) can still further include supplying timeout information in response to the state machine transitioning from the second state to the first state. The timeout information can be either defined information (a string of characters, a data structure, or similar) or a void datum.

Numerous example embodiments emerge from the foregoing detailed description and annexed drawings. Such example embodiments include the following:

Example 1. A method comprising: generating a language model based on multiple keyphrases; merging the language model with a second language model that is based on an ordinary spoken natural language, resulting in a keyphrase recognition model; receiving an audio signal representative of speech; and detecting, based on applying the keyphrase recognition model to the speech, a particular keyphrase of the multiple keyphrases.

Example 2. The method of Example 1 further comprising, in response to the detecting, causing an apparatus to execute one or more control operations.

Example 3. The method of any one of Example 1 or Example 2, wherein the generating comprises: accessing the multiple keyphrases; generating one or more prefixes for each keyphrase of the multiple keyphrases; and generating, using the one or more prefixes and each keyphrase, a domain-specific finite state transducer (FST) representing the one or more prefixes and each keyphrase of the multiple keyphrases, resulting in the language model.

Example 4. The method of any one of Example 1 to Example 3, wherein the second language model corresponds to a wide-vocabulary FST representing the ordinary spoken natural language.

Example 5. The method of any one of Example 1 to Example 3, wherein the accessing comprises reading a text file within a filesystem of a computing device, the text file defining the multiple keyphrases.

Example 6. The method of any one of Example 1 to Example 5, wherein the detecting comprises: determining, using the keyphrase recognition model, a sequence of words within the speech during a first time interval; and determining that a suffix of the sequence of words corresponds to the particular keyphrase.

Example 7. The method of any one of Example 1 to Example 6, wherein the detecting further comprises generating confirmation data indicative of the particular keyphrase being present in the speech in the first time interval.

Example 8. The method of any one of Example 1 to Example 7, wherein the detecting further comprises updating a state variable for the particular keyphrase to a value indicating that the particular keyphrase has been detected in the sequence of words associated with the first time interval.

Example 9. The method of any one of Example 1 to Example 6, wherein the detecting further comprises: determining that the particular keyphrase is associated with a non-zero latency parameter; and updating a state variable for the particular keyphrase to a first value indicating that the particular keyphrase has been recognized in the speech during the first time interval.

Example 10. The method of any one of Example 1 to Example 9, wherein the detecting further comprises: determining, using the keyphrase recognition model, a second sequence of words within the speech during a second time interval after the first time interval; and determining that a second suffix of the second sequence of words corresponds to the particular keyphrase.

Example 11. The method of any one of Example 1 to Example 10, wherein the detecting further comprises generating confirmation data indicative of the particular keyphrase being present in the speech in the second time interval.

Example 12. The method of any one of Example 1 to Example 11, wherein the detecting further comprises updating the state variable for the particular keyphrase to a second value indicating that the particular keyphrase has been detected in the second sequence of words associated with the second time interval.

Example 13. The method of any one of Example 1 to Example 10, wherein the first time interval spans a defined time period and the second time interval spans the defined time period, and wherein the second time interval begins immediately after the first time interval elapses.

Example 14. The method of any one of Example 1 to Example 10, wherein the first time interval spans a defined time period and the second time interval spans the defined time period, and wherein the second time interval begins after the first time interval elapsed and ends when a confirmation period elapses.

Example 15. The method of any one of Example 1 to Example 14, wherein the confirmation period corresponds to a multiple of the defined time period.

Example 16. A system of devices, comprising: at least one processor; and at least one memory device storing processor-executable instructions that, in response to being executed by the at least one processor, cause the system at least to: generate a language model based on multiple keyphrases; merge the language model with a second language model that is based on an ordinary spoken natural language, resulting in a keyphrase recognition model; receive an audio signal representative of speech; and detect, based on applying the keyphrase recognition model to the speech, a particular keyphrase of the multiple keyphrases.

Example 17. The system of Example 16, wherein the processor-executable instructions, in response to execution by the at least one processor, further cause the system to cause an apparatus to execute one or more control operations in response to the detecting.

Example 18. The system of any one of Example 16 or Example 17, wherein generating the language model based on the multiple keyphrases comprises: accessing the multiple keyphrases; generating one or more prefixes for each keyphrase of the multiple keyphrases; and generating, using the one or more prefixes and each keyphrase, a domain-specific finite state transducer (FST) representing the one or more prefixes and each keyphrase of the multiple keyphrases, resulting in the language model.

Example 19. The system of any one of Example 16 to Example 18, wherein the second language model corresponds to a wide-vocabulary FST representing the ordinary spoken natural language.

Example 20. The system of any one of Example 16 to Example 18, wherein the accessing comprises reading a text file within a filesystem of a device of the system of devices, the text file defining the multiple keyphrases.

Example 21. The system of any one of Example 16 to Example 20, wherein detecting, based on applying the keyphrase recognition model to the speech, the particular keyphrase of the multiple keyphrases comprises: determining, using the keyphrase recognition model, a sequence of words within the speech during a first time interval; and determining that a suffix of the sequence of words corresponds to the particular keyphrase.

Example 22. The system of any one of Example 16 to Example 21, wherein the detecting further comprises generating confirmation data indicative of the particular keyphrase being present in the speech in the first time interval.

Example 23. The system of any one of Example 16 to Example 22, wherein the detecting further comprises updating a state variable for the particular keyphrase to a value indicating that the particular keyphrase has been detected in the sequence of words associated with the first time interval.

Example 24. The system of any one of Example 16 to Example 21, wherein the detecting further comprises: determining that the particular keyphrase is associated with a non-zero latency parameter; and updating a state variable for the particular keyphrase to a first value indicating that the particular keyphrase has been recognized in the speech during the first time interval.

Example 25. The system of any one of Example 16 to Example 24, wherein the detecting further comprises: determining, using the keyphrase recognition model, a second sequence of words within the speech during a second time interval after the first time interval; and determining that a second suffix of the second sequence of words corresponds to the particular keyphrase.

Example 26. The system of any one of Example 16 to Example 25, wherein the detecting further comprises generating confirmation data indicative of the particular keyphrase being present in the speech in the second time interval.

Example 27. The system of any one of Example 16 to Example 26, wherein the detecting further comprises updating the state variable for the particular keyphrase to a second value indicating that the particular keyphrase has been detected in the second sequence of words associated with the second time interval.

Example 28. The system of any one of Example 16 to Example 25, wherein the first time interval spans a defined time period and the second time interval spans the defined time period, and wherein the second time interval begins immediately after the first time interval elapses.

Example 29. The system of any one of Example 16 to Example 25, wherein the first time interval spans a defined time period and the second time interval spans the defined time period, and wherein the second time interval begins after the first time interval elapsed and ends when a confirmation period elapses.

Example 30. The system of any one of Example 16 to Example 29, wherein the confirmation period corresponds to a multiple of the defined time period.

Example 31. At least one non-transitory processor-readable storage medium having processor-executable instructions encoded thereon that, in response to execution, cause a system of devices to perform operations comprising: generating a language model based on multiple keyphrases; merging the language model with a second language model that is based on an ordinary spoken natural language, resulting in a keyphrase recognition model; receiving an audio signal representative of speech; and detecting, based on applying the keyphrase recognition model to the speech, a particular keyphrase of the multiple keyphrases. The processor-executable instructions are executed by at least one processor, individually or in combination.

Example 32. The at least one non-transitory processor-readable storage medium of Example 31, wherein the operations further comprise, in response to the detecting, causing an apparatus to execute one or more control operations.

Example 33. The at least one non-transitory processor-readable storage medium of any one of Example 31 or Example 32, wherein the generating comprises: accessing the multiple keyphrases; generating one or more prefixes for each keyphrase of the multiple keyphrases; and generating, using the one or more prefixes and each keyphrase, a domain-specific finite state transducer (FST) representing the one or more prefixes and each keyphrase of the multiple keyphrases, resulting in the language model.

Example 34. The at least one non-transitory processor-readable storage medium of any one of Example 31 to Example 33, wherein the second language model corresponds to a wide-vocabulary FST representing the ordinary spoken natural language.

Example 35. The at least one non-transitory processor-readable storage medium of any one of Example 31 to Example 33, wherein the accessing comprises reading a text file within a filesystem of a computing device, the text file defining the multiple keyphrases.

Example 36. The at least one non-transitory processor-readable storage medium of any one of Example 31 to Example 35, wherein the detecting comprises: determining, using the keyphrase recognition model, a sequence of words within the speech during a first time interval; and determining that a suffix of the sequence of words corresponds to the particular keyphrase.

Example 37. The at least one non-transitory processor-readable storage medium of any one of Example 31 to Example 36, wherein the detecting further comprises generating confirmation data indicative of the particular keyphrase being present in the speech in the first time interval.

Example 38. The at least one non-transitory processor-readable storage medium of any one of Example 31 to Example 37, wherein the detecting further comprises updating a state variable for the particular keyphrase to a value indicating that the particular keyphrase has been detected in the sequence of words associated with the first time interval.

Example 39. The at least one non-transitory processor-readable storage medium of any one of Example 31 to Example 36, wherein the detecting further comprises: determining that the particular keyphrase is associated with a non-zero latency parameter; and updating a state variable for the particular keyphrase to a first value indicating that the particular keyphrase has been recognized in the speech during the first time interval.

Example 40. The at least one non-transitory processor-readable storage medium of any one of Example 31 to Example 39, wherein the detecting further comprises: determining, using the keyphrase recognition model, a second sequence of words within the speech during a second time interval after the first time interval; and determining that a second suffix of the second sequence of words corresponds to the particular keyphrase.

Example 41. The at least one non-transitory processor-readable storage medium of any one of Example 31 to Example 40, wherein the detecting further comprises generating confirmation data indicative of the particular keyphrase being present in the speech in the second time interval.

Example 42. The at least one non-transitory processor-readable storage medium of any one of Example 31 to Example 41, wherein the detecting further comprises updating the state variable for the particular keyphrase to a second value indicating that the particular keyphrase has been detected in the second sequence of words associated with the second time interval.

Example 43. The at least one non-transitory processor-readable storage medium of any one of Example 31 to Example 40, wherein the first time interval spans a defined time period and the second time interval spans the defined time period, and wherein the second time interval begins immediately after the first time interval elapses.

Example 44. The at least one non-transitory processor-readable storage medium of any one of Example 31 to Example 40, wherein the first time interval spans a defined time period and the second time interval spans the defined time period, and wherein the second time interval begins after the first time interval elapsed and ends when a confirmation period elapses.

Example 45. The at least one non-transitory processor-readable storage medium of any one of Example 31 to Example 44, wherein the confirmation period corresponds to a multiple of the defined time period.

Example 46. A method comprising: receiving, by an apparatus, an audio signal representative of speech; detecting, based on applying a keyphrase recognition model to the speech, one or more particular keyphrases of multiple keyphrases, wherein the keyphrase recognition model is based on the multiple keyphrases; and causing, by applying a state machine, the apparatus to perform one or more control operations based on the one or more particular keyphrases, wherein the state machine is based on a subset of the multiple keyphrases.

Example 47. The method of Example 46, further comprising receiving the keyphrase recognition model prior to the detecting.

Example 48. The method of any one of Example 46 or Example 47, further comprising obtaining the state machine prior to the causing, the obtaining comprising receiving a listing of statements defining a graph that represents the state machine.

Example 49. The method of any one of Example 46 to Example 48, wherein the receiving the listing of statements comprises receiving one or more of: a first statement defining an input event that causes a state transition in the state machine, wherein the event comprises detection of a keyphrase; a second statement defining multiple nodes in the graph; or a third statement defining an edge in the graph, the third statement comprising multiple fields including a first field corresponding to a first unique identifier indicative of an originating node for the edge, a second field corresponding to a second unique identifier indicative of a terminating node for the edge, a third field indicative of the input event, and a fourth field defining output data in response to the state transition.

Example 50. The method of any one of Example 46 to Example 49, wherein the causing, by applying the state machine, the apparatus to perform the one or more control operations comprises: determining that a first particular keyphrase of the one or more particular keyphrases corresponds to a first input event of the state machine, the first input event causing the state machine to transition from a first state to a second state; and supplying output data indicative of one of the first particular keyphrase or a defined keyphrase, the output data causing the apparatus to perform a first control operation of the one or more control operations.

Example 51. The method of any one of Example 46 to Example 50, wherein the causing, by applying the state machine, the apparatus to perform the one or more control operations further comprises: determining that a second particular keyphrase of the one or more particular keyphrases corresponds to a second input event of the state machine, the second input event causing the state machine to transition from a second state to the second state; and supplying second output data indicative of one of the second particular keyphrase or a second defined keyphrase, the second output data causing the apparatus to perform a second control operation of the one or more control operations.

Example 52. The method of any one of Example 46 to Example 50, wherein the causing, by applying the state machine, the apparatus to perform the one or more control operations further comprises: determining that a time interval corresponding to a time-to-live of the second state has elapsed; and causing the state machine to transition from the second state to the first state.

Example 53. The method of any one of Example 46 to Example 52, further comprising supplying timeout information in response to the state machine transitioning from the second state to the first state.

Example 54. An apparatus comprising: at least one processor; and at least one memory device storing processor-executable instructions that, in response to being executed by the at least one processor, cause the apparatus at least to: receive an audio signal representative of speech; detect, based on applying a keyphrase recognition model to the speech, one or more particular keyphrases of multiple keyphrases, wherein the keyphrase recognition model is based on the multiple keyphrases; and cause, by applying a state machine, execution of one or more control operations based on the one or more particular keyphrases, wherein the state machine is based on a subset of the multiple keyphrases.

Example 55. The apparatus of Example 54, wherein the processor-executable instructions, in further response to execution by the at least one processor, further cause the apparatus to obtain the state machine by at least receiving a listing of statements defining a graph that represents the state machine.

Example 56. The apparatus of any one of Example 54 or Example 55, wherein to cause, by applying the state machine, the execution of the one or more control operations, the processor-executable instructions, in response to being further executed, further cause the apparatus to: determine that a first particular keyphrase of the one or more particular keyphrases corresponds to a first input event of the state machine, the first input event causing the state machine to transition from a first state to a second state; and supply output data indicative of one of the first particular keyphrase or a defined keyphrase, the output data causing the apparatus to perform execution of a first control operation of the one or more control operations.

Example 57. The apparatus of any one of Example 54 to Example 56, wherein to cause, by applying the state machine, the execution of the one or more control operations, the processor-executable instructions, in response to being further executed, further cause the apparatus to: determine that a second particular keyphrase of the one or more particular keyphrases corresponds to a second input event of the state machine, the second input event causing the state machine to transition from the second state to the second state; and supply second output data indicative of one of the second particular keyphrase or a second defined keyphrase, the second output data causing the apparatus to perform execution of a second control operation of the one or more control operations.

Example 58. The apparatus of any one of Example 54 to Example 57, wherein to cause, by applying the state machine, the execution of the one or more control operations, the processor-executable instructions, in response to being further executed, further cause the apparatus to: determine that a time interval corresponding to a time-to-live of the second state has elapsed; and cause the state machine to transition from the second state to the first state.

Example 59. The apparatus of any one of Example 54 to Example 58, further comprising supplying information in response to the state machine transitioning from the second state to the first state.

Example 60. At least one non-transitory processor-readable storage medium having processor-executable instructions encoded thereon that, in response to execution, cause an apparatus to perform operations comprising: receiving an audio signal representative of speech; detecting, based on applying a keyphrase recognition model to the speech, one or more particular keyphrases of multiple keyphrases, wherein the keyphrase recognition model is based on the multiple keyphrases; and causing, by applying a state machine, execution of one or more control operations based on the one or more particular keyphrases, wherein the state machine is based on a subset of the multiple keyphrases. The processor-executable instructions are executed by at least one processor, individually or in combination.

Example 61. The at least one non-transitory processor-readable storage medium of Example 60, the operations further comprising obtaining the state machine, the obtaining comprising receiving a listing of statements defining a graph that represents the state machine.

Example 62. The at least one non-transitory processor-readable storage medium of any one of Example 60 or Example 61, wherein the causing, by applying the state machine, the execution of the one or more control operations comprises: determining that a first particular keyphrase of the one or more particular keyphrases corresponds to a first input event of the state machine, the first input event causing the state machine to transition from a first state to a second state; and supplying output data indicative of one of the first particular keyphrase or a defined keyphrase, the output data causing the apparatus to perform a first control operation of the one or more control operations.

Example 63. The at least one non-transitory processor-readable storage medium of any one of Example 60 to Example 62, wherein the causing, by applying the state machine, the execution of the one or more control operations further comprises: determining that a second particular keyphrase of the one or more particular keyphrases corresponds to a second input event of the state machine, the second input event causing the state machine to transition from a second state to the second state; and supplying second output data indicative of one of the second particular keyphrase or a second defined keyphrase, the second output data causing the apparatus to perform a second control operation of the one or more control operations.

Example 64. The at least one non-transitory processor-readable storage medium of any one of Example 60 to Example 62, wherein the causing, by applying the state machine, the execution of the one or more control operations further comprises: determining that a time interval corresponding to a time-to-live of the second state has elapsed; and causing the state machine to transition from the second state to the first state.

Example 65. The at least one non-transitory processor-readable storage medium of any one of Example 60 to Example 64, the operations further comprising supplying timeout information in response to the state machine transitioning from the second state to the first state.

Various aspects of the disclosure may take the form of an entirely or partially hardware aspect, an entirely or partially software aspect, or a combination of software and hardware. Furthermore, as described herein, various aspects of the disclosure (e.g., systems and methods) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, and so forth.

Aspects of this disclosure are described herein with reference to block diagrams and flowchart illustrations of methods, systems, apparatuses and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general purpose computer, a special purpose computer, or another programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of aspects described in the specification or annexed drawings; or the like.

As used in this disclosure, including the annexed drawings, the terms “component,” “module,” “system,” and the like are intended to refer to a computer-related entity or an entity related to an apparatus with one or more specific functionalities. The entity can be either hardware, a combination of hardware and software, software, or software in execution. One or more of such entities are also referred to as “functional elements.” As an example, a component can be a process running on a processor, a processor, an object, an executable, a thread of execution, a program, and/or a computer. For example, both an application running on a server or network controller, and the server or network controller can be a component. One or more components can reside within a process and/or thread of execution and a component can be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which parts can be controlled or otherwise operated by program code executed by a processor. As yet another example, a component can be an apparatus that provides specific functionality through electronic components without mechanical parts, the electronic components can include a processor to execute program code that provides, at least partially, the functionality of the electronic components. As still another example, interface(s) can include I/O components or Application Programming Interface (API) components. While the foregoing examples are directed to aspects of a component, the exemplified aspects or features also apply to a system, module, and similar.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should be construed to mean “one or more” unless specified otherwise or clear from context to be directed to a singular form.

In addition, the terms “example” and “such as” are utilized herein to mean serving as an instance or illustration. Any aspect or design described herein as an “example” or referred to in connection with a “such as” clause is not necessarily to be construed as preferred or advantageous over other aspects or designs described herein. Rather, use of the terms “example” or “such as” is intended to present concepts in a concrete fashion. The terms “first,” “second,” “third,” and so forth, as used in the claims and description, unless otherwise clear by context, is for clarity only and doesn't necessarily indicate or imply any order in time or space.

The term “processor,” as utilized in this disclosure, can refer to any computing processing unit or device comprising processing circuitry that can operate on data and/or signaling. A computing processing unit or device can include, for example, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. In some cases, processors can exploit nano-scale architectures, such as molecular and quantum-dot based transistors, switches and gates, in order to optimize space usage or enhance performance of user equipment. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. Moreover, a memory component can be removable or affixed to a functional element (e.g., device, server).

Simply as an illustration, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects described herein can be implemented as a method, apparatus, or article of manufacture using standard programming and/or engineering techniques. In addition, various of the aspects disclosed herein also can be implemented by means of program modules or other types of computer program instructions stored in a memory device and executed by a processor, or other combination of hardware and software, or hardware and firmware. Such program modules or computer program instructions can be loaded onto a general purpose computer, a special purpose computer, or another type of programmable data processing apparatus to produce a machine, such that the instructions which execute on the computer or other programmable data processing apparatus create a means for implementing the functionality of disclosed herein.

The terminology “article of manufacture” as used herein is intended to encompass a computer program or other type of machine instructions stored in and accessible from any processor-readable (e.g., computer-readable) device, carrier, or media. For example, processor-readable (e.g., computer readable) media can include magnetic storage devices (e.g., hard drive disk, floppy disk, magnetic strips, or similar), optical discs (e.g., compact disc (CD), digital versatile disc (DVD), blu-ray disc (BD), or similar), smart cards, and flash memory devices (e.g., card, stick, key drive, or similar), and other types of memory devices.

What has been described above includes examples of one or more aspects of the disclosure. It is, of course, not possible to describe every conceivable combination of components or methodologies for purposes of describing these examples, and it can be recognized that many further combinations and permutations of the present aspects are possible. Accordingly, the aspects disclosed and/or claimed herein are intended to embrace all such alterations, modifications and variations that fall within the spirit and scope of the detailed description and the appended claims. Furthermore, to the extent that one or more of the terms “includes,” “including,” “has,” “have,” or “having” is used in either the detailed description or the claims, such term is intended to be inclusive in a manner similar to the term “comprising” as “comprising” is interpreted when employed as a transitional word in a claim.

1. A method comprising:
receiving, by an apparatus, an audio signal representative of speech;
detecting, based on applying a keyphrase recognition model to the speech, one or more particular keyphrases of multiple keyphrases, wherein the keyphrase recognition model is based on the multiple keyphrases;
causing, by applying a state machine, the apparatus to perform one or more control operations based on the one or more particular keyphrases, wherein the state machine is based on a subset of the multiple keyphrases; and
obtaining the state machine prior to the causing, the obtaining comprising receiving a listing of statements defining a graph that represents the state machine.

2. The method of claim 1, further comprising receiving the keyphrase recognition model prior to the detecting.

3. (canceled)

4. The method of claim 1, wherein the receiving the listing of statements comprises receiving one or more of:
a first statement defining an input event that causes a state transition in the state machine, wherein the event comprises detection of a keyphrase;
a second statement defining multiple nodes in the graph; or
a third statement defining an edge in the graph, the third statement comprising multiple fields including a first field corresponding to a first unique identifier indicative of an originating node for the edge, a second field corresponding to a second unique identifier indicative of a terminating node for the edge, a third field indicative of the input event, and a fourth field defining output data in response to the state transition.

5. The method of claim 1, wherein the causing, by applying the state machine, the apparatus to perform the one or more control operations comprises:
determining that a first particular keyphrase of the one or more particular keyphrases corresponds to a first input event of the state machine, the first input event causing the state machine to transition from a first state to a second state; and
supplying output data indicative of one of the first particular keyphrase or a defined keyphrase, the output data causing the apparatus to perform a first control operation of the one or more control operations.

6. The method of claim 1, wherein the causing, by applying the state machine, the apparatus to perform the one or more control operations further comprises:
determining that a second particular keyphrase of the one or more particular keyphrases corresponds to a second input event of the state machine, the second input event causing the state machine to transition from a second state to the second state; and
supplying second output data indicative of one of the second particular keyphrase or a second defined keyphrase, the second output data causing the apparatus to perform a second control operation of the one or more control operations.

7. The method of claim 1, wherein the causing, by applying the state machine, the apparatus to perform the one or more control operations further comprises:
determining that a time interval corresponding to a time-to-live of the second state has elapsed; and
causing the state machine to transition from the second state to the first state.

8. The method of claim 1, further comprising supplying timeout information in response to the state machine transitioning from the second state to the first state.

9. An apparatus comprising:
at least one processor; and
at least one memory device storing processor-executable instructions that, in response to being executed by the at least one processor, cause the apparatus at least to:
receive an audio signal representative of speech;
detect, based on applying a keyphrase recognition model to the speech, one or more particular keyphrases of multiple keyphrases, wherein the keyphrase recognition model is based on the multiple keyphrases;
cause, by applying a state machine, execution of one or more control operations based on the one or more particular keyphrases, wherein the state machine is based on a subset of the multiple keyphrases; and
cause the apparatus to obtain the state machine by at least receiving a listing of statements defining a graph that represents the state machine.

10. (canceled)

11. The apparatus of claim 9, wherein to cause, by applying the state machine, the execution of the one or more control operations, the processor-executable instructions, in response to being further executed, further cause the apparatus to:
determine that a first particular keyphrase of the one or more particular keyphrases corresponds to a first input event of the state machine, the first input event causing the state machine to transition from a first state to a second state; and
supply output data indicative of one of the first particular keyphrase or a defined keyphrase, the output data causing the apparatus to perform execution of a first control operation of the one or more control operations.

12. The apparatus of claim 9, wherein to cause, by applying the state machine, the execution of the one or more control operations, the processor-executable instructions, in response to being further executed, further cause the apparatus to:
determine that a second particular keyphrase of the one or more particular keyphrases corresponds to a second input event of the state machine, the second input event causing the state machine to transition from the second state to the second state; and
supply second output data indicative of one of the second particular keyphrase or a second defined keyphrase, the second output data causing the apparatus to perform execution of a second control operation of the one or more control operations.

13. The apparatus of claim 9, wherein to cause, by applying the state machine, the execution of the one or more control operations, the processor-executable instructions, in response to being further executed, further cause the apparatus to:
determine that a time interval corresponding to a time-to-live of the second state has elapsed; and
cause the state machine to transition from the second state to the first state.

14. The apparatus of claim 9, further comprising supplying information in response to the state machine transitioning from the second state to the first state.

15. At least one non-transitory processor-readable storage medium having processor-executable instructions encoded thereon that, in response to execution, cause an apparatus to perform operations comprising:
receiving an audio signal representative of speech;
detecting, based on applying a keyphrase recognition model to the speech, one or more particular keyphrases of multiple keyphrases, wherein the keyphrase recognition model is based on the multiple keyphrases;
causing, by applying a state machine, execution of one or more control operations based on the one or more particular keyphrases, wherein the state machine is based on a subset of the multiple keyphrases; and
obtaining the state machine, the obtaining comprising receiving a listing of statements defining a graph that represents the state machine.

16. (canceled)

17. The at least one non-transitory processor-readable storage medium of claim 15, wherein the causing, by applying the state machine, the execution of the one or more control operations comprises:
determining that a first particular keyphrase of the one or more particular keyphrases corresponds to a first input event of the state machine, the first input event causing the state machine to transition from a first state to a second state; and
supplying output data indicative of one of the first particular keyphrase or a defined keyphrase, the output data causing the apparatus to perform a first control operation of the one or more control operations.

18. The at least one non-transitory processor-readable storage medium of claim 15, wherein the causing, by applying the state machine, the execution of the one or more control operations further comprises:
determining that a second particular keyphrase of the one or more particular keyphrases corresponds to a second input event of the state machine, the second input event causing the state machine to transition from a second state to the second state; and
supplying second output data indicative of one of the second particular keyphrase or a second defined keyphrase, the second output data causing the apparatus to perform a second control operation of the one or more control operations.

19. The at least one non-transitory processor-readable storage medium of claim 15, wherein the causing, by applying the state machine, the execution of the one or more control operations further comprises:
determining that a time interval corresponding to a time-to-live of the second state has elapsed; and
causing the state machine to transition from the second state to the first state.

20. The at least one non-transitory processor-readable storage medium of claim 15, the operations further comprising supplying timeout information in response to the state machine transitioning from the second state to the first state.
